(19) United States
(12) Patent Application Publication
(10) Pub. No.: US 2026/0089569 A1
(43) Pub. Date: Mar. 26, 2026

(54) METHOD AND APPARTUS FOR CONFIGURING FRAME FOR PERFORMING TEARDOWN OF MAPC AGREEMENT IN WIRELESS LAN SYSTEM

(71) Applicant: LG ELECTRONICS INC., Seoul (KR)

(72) Inventors: Geonhwan KIM, Seoul (KR); Jinsoo CHOI, Seoul (KR); Hongwon LEE, Seoul (KR); Insun JANG, Seoul (KR); Sunhee BAEK, Seoul (KR); Yelin YOON, Seoul (KR); Dongju CHA, Seoul (KR)

(73) Assignee: LG ELECTRONICS INC., Seoul (KR)

(21) Appl. No.: 19/335,490

(22) Filed: Sep. 22, 2025

(30) Foreign Application Priority Data
Sep. 25, 2024 (KR) 10-2024-0130161
Mar. 14, 2025 (KR) 10-2025-0033472
Apr. 8, 2025 (KR) 10-2025-0045728

(51) Int. Cl. H04W 28/18; H04W 84/12; H04W 88/08

(52) U.S. Cl. CPC H04W 28/18; H04W 84/12; H04W 88/08

(57) ABSTRACT

A method and apparatus for configuring a frame for performing a teardown of a MAPC agreement in a wireless LAN system are proposed. Specifically, a first AP transmits a negotiation request frame to a second AP. The first AP performs the teardown of the MAPC agreement with the second AP based on the negotiation request frame. The negotiation request frame is a public action frame having a first value of a public action field. The negotiation request frame is used to teardown the MAPC agreement.

### CROSS-REFERENCE TO RELATED APPLICATIONS

Pursuant to 35 U.S.C. § 119(a), this application claims the benefit of earlier filing date and right of priority to Korean Patent Application Nos. 10-2024-0130161, filed on Sep. 25, 2024, 10-2025-0033472, filed on Mar. 14, 2025, and 10-2025-0045728, filed on Apr. 8, 2025, the contents of which are all hereby incorporated by reference herein in their entireties.

### TECHNICAL FIELD

specification relates to a technique for configuring a frame for performing teardown of a MAPC agreement in a wireless LAN system, and more specifically, to a method and device for performing of the teardown the MAPC agreement by defining a negotiation request frame based on a reserved value of a public action field of a public action frame.

### BACKGROUND

Next-generation Wi-Fi (e.g., IEEE 802.11be and/or later) aims to support ultra-high reliability when transmitting signals to STAs. To achieve this, various technologies are being considered to support high throughput, low latency, and extended range. For example, multiple APs can cooperate to perform TXOP sharing procedures.

### SUMMARY

This specification proposes a method and device configuring a frame for performing teardown of a MAPC agreement in a wireless LAN system.

An example of this specification proposes a method for configuring a frame for performing teardown of a MAPC agreement.

This embodiment may be performed in a network environment that supports a next-generation wireless LAN system (Ultra High Reliability (UHR) wireless LAN system or next Wi-Fi). The next-generation wireless LAN system is an improved version of the 802.11be system and can satisfy backward compatibility with the 802.11be system.

This embodiment may be performed in a first AP. The first AP may be a MAPC requesting AP that initiates MAPC negotiation with a second AP for at least one MAPC scheme. The second AP may be a MAPC responding AP that responds to the MAPC requesting AP. Furthermore, the first and second APs may be configured as coordinating APs or coordinated APs through the MAPC negotiation.

This embodiment proposes a method for defining a frame for performing teardown of a MAPC agreement established through MAPC negotiation. Specifically, this embodiment proposes a method for performing the teardown of the MAPC agreement by defining a negotiation request frame based on a reserved value in the public action field of a public action frame.

A first access point (AP) transmits a negotiation request frame to a second AP.

The first AP performs a teardown of a Multi-AP Coordination (MAPC) agreement with the second AP based on the negotiation request frame.

The first AP is a MAPC requesting AP that initiates negotiation for the MAPC agreement. The second AP is a MAPC responding AP that responds to the MAPC requesting AP.

The negotiation request frame is a public action frame having a first value of a public action field. The negotiation request frame is used to teardown the MAPC agreement.

The first value may be set to one of reserved values (e.g., 54 to 59 and 61 to 255) of the public action field for 802.11be wireless LAN systems. For example, the first value may be 69.

That is, the present embodiment proposes a method for performing teardown of MAPC agreement by defining a negotiation request frame (or MAPC negotiation request frame) based on a public action frame.

According to the embodiment proposed in this specification, since the negotiation request frame defined based on the public action frame can be classified as a Class 1 frame, it has the effect that it can be transmitted even between APs that are in an unauthenticated and unassociated relationship, or an authenticated but unassociated relationship. In addition, since there is no need to define a separate dedicated management frame for each procedure such as discovery for MAPC, negotiation for MAPC agreement (MAPC agreement establish, MAPC agreement update, MAPC agreement teardown), etc., it has the effect that not only MAPC agreement teardown based on the negotiation request frame, but also other negotiation procedures may be performed.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 shows an example of a multi-link (ML).

FIG. 5 shows an example of a physical protocol data unit or physical layer (PHY) protocol data unit (PPDU) transmitted/received by an STA of the present disclosure.

FIG. 6 is a diagram illustrating the layout of resource units (RUs) used for a 20 MHz PPDU.

FIG. 7 is a diagram illustrating the layout of resource units (RUs) used for 40 MHz PPDU.

FIG. 8 is a diagram illustrating the layout of resource units (RUs) used for an 80 MHz PPDU.

FIG. 9 shows an operation related to UL-MU.

FIG. 10 illustrates an example of channels used/supported/defined within the 2.4 GHz band

FIG. 11 illustrates an example of channels used/supported/defined within the 5 GHz band.

FIG. 12 illustrates an example of channels used/supported/defined within the 6 GHz band.

FIG. 13 illustrates an example of a modified transmission device and/or receiving device of the present specification.

FIG. 14 illustrates operation according to a conventional STX operation.

FIG. 15 illustrates an example of Coordinated OFDMA (C-OFDMA).

FIG. 16 illustrates an example of Coordinated Beamforming (CBF).

FIG. 17 illustrates an example of AP selection.

FIG. 18 illustrates an example of JTX/JT.

FIG. 19 illustrates an example of the operation of an MU-RTS TXS trigger frame in which the TXOP Sharing Mode subfield value is 2.

FIG. 20 illustrates an example of coordinated TDMA operation, including a negotiation process.

FIG. 21 illustrates an example of a MAPC element format.

FIG. 22 illustrates another example of a MAPC element format.

FIG. 23 illustrates an example of a MAPC element format including a MAPC Control field, a MAPC Common Info field, and a MAPC Schemes Info field.

FIG. 24 illustrates another example of a MAPC element format including a MAPC Control field, a MAPC Common Info field, and a MAPC Schemes Info field.

FIG. 25 illustrates an example of a MAPC teardown operation.

FIG. 26 illustrates another example of a MAPC teardown operation.

FIG. 27 is a flowchart illustrating the operation of a transmitting device according to the present embodiment.

FIG. 28 is a flowchart illustrating the operation of a receiving device according to the present embodiment.

FIG. 29 is a flowchart illustrating a procedure for receiving a frame for performing teardown of a MAPC agreement according to the present embodiment.

FIG. 30 is a flowchart illustrating a procedure for configuring a frame for performing teardown of a MAPC agreement according to the present embodiment.

### DETAILED DESCRIPTION

In the present disclosure, “A or B” may mean “only A”, “only B” or “both A and B”. In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, a parenthesis used in the present disclosure may mean “for example”. Specifically, when indicated as “control information (UHR-signal field)”, it may mean that “UHR-signal field” is proposed as an example of the “control information”. In other words, the “control information” of the present disclosure is not limited to “UHR-signal field”, and “UHR-signal field” may be proposed as an example of the “control information”. In addition, when indicated as “control information (i.e., UHR-signal field)”, it may also mean that “UHR-signal field” is proposed as an example of the “control information”.

Also, “a/an” as used in this disclosure can mean “at least one” or “one or more.” Also, a term ending with “(s)” can mean “at least one” or “one or more.”

Also, the expressions “based on” or “on the basis of” or “according to” as used in this disclosure mean “based at least in part on,” and do not mean “based sonly on.”

Technical features described individually in one figure in the present disclosure may be individually implemented, or may be simultaneously implemented.

The following example of the present disclosure may be applied to various wireless communication systems. For example, the following example of the present disclosure may be applied to a wireless local area network (WLAN) system. For example, the present disclosure may be applied to the IEEE 802.11a/g/n/ac/ax/be/bn standard. In addition, an example of the present disclosure can also be applied to a next-generation wireless LAN standard that enhances the Ultra High Reliability (UHR) standard or IEEE 802.11bn. In addition, the example of the present disclosure may also be applied to a new WLAN standard enhanced from the EHT standard or the IEEE 802.11be standard. In addition, the example of the present disclosure may be applied to a mobile communication system. For example, it may be applied to a mobile communication system based on long term evolution (LTE) depending on a 3rd generation partnership project (3GPP) standard and based on evolution of the LTE. In addition, the example of the present disclosure may be applied to a communication system of a 5G NR standard based on the 3GPP standard.

Hereinafter, in order to describe a technical feature of the present disclosure, a technical feature applicable to the present disclosure will be described.

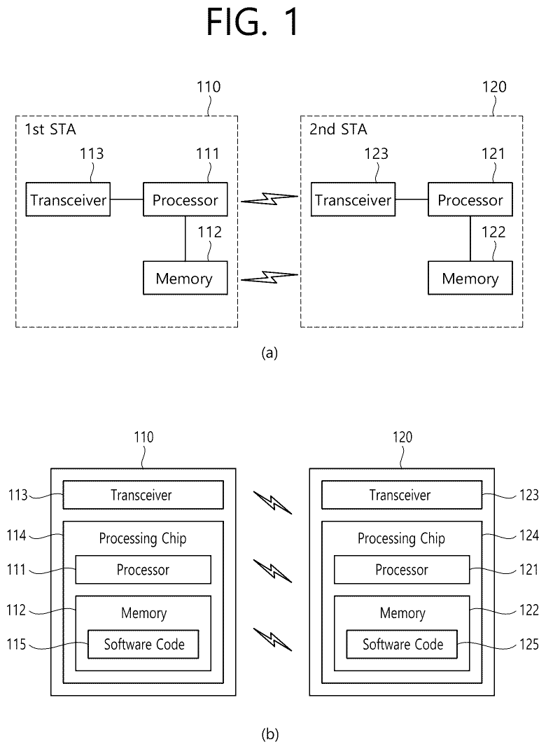

FIG. 1 shows an example of a transmitting apparatus and/or receiving apparatus of the present disclosure.

In the example of FIG. 1, various technical features described below may be performed. FIG. 1 relates to at least one station (STA). For example, STAs 110 and 120 of the present disclosure may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present disclosure may also be called in various terms such as a network, a base station, a node-B, an access point (AP), a repeater, a router, a relay, or the like. The STAs 110 and 120 of the present disclosure may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present disclosure may serve as the AP and/or the non-AP. In the present disclosure, the AP may be indicated as an AP STA.

The STAs 110 and 120 of the present disclosure may support various communication standards together in addition to the IEEE 802.11 standard. For example, a communication standard (e.g., LTE, LTE-A, 5G NR standard) or the like based on the 3GPP standard may be supported. In addition, the STA of the present disclosure may be implemented as various devices such as a mobile phone, a vehicle, a personal computer, or the like. In addition, the STA of the present disclosure may support communication for various communication services such as voice calls, video calls, data communication, and self-driving (autonomous-driving), or the like.

The STAs 110 and 120 of the present disclosure may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the disclosure described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the disclosure described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the disclosure described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for and an the STA; 5) operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present disclosure will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present disclosure may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by Media Tek®, ATOM™ series of processors made by Intel® or processors enhanced from these processors.

In the present disclosure, an uplink may imply a link for communication from a non-AP STA to an AP STA, and an uplink PPDU/packet/signal or the like may be transmitted through the uplink. In addition, in the present disclosure, a downlink may imply a link for communication from the AP STA to the non-AP STA, and a downlink PPDU/packet/signal or the like may be transmitted through the downlink.

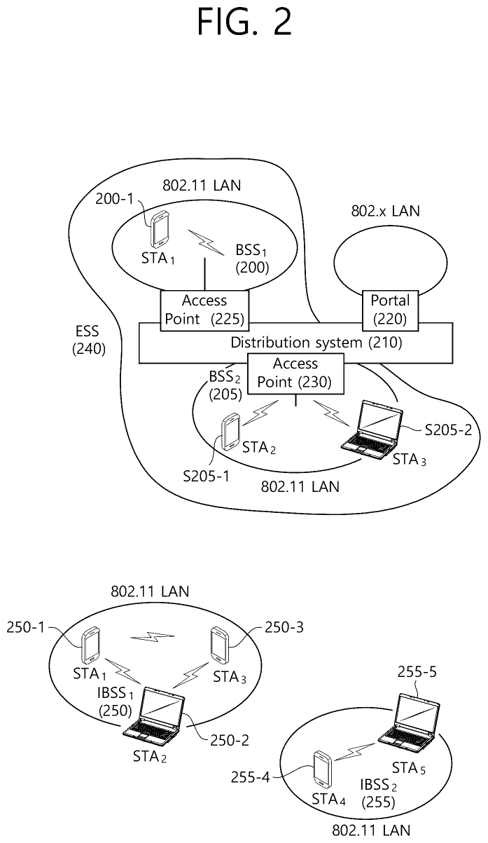

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and an STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, an AP 225, 230 providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

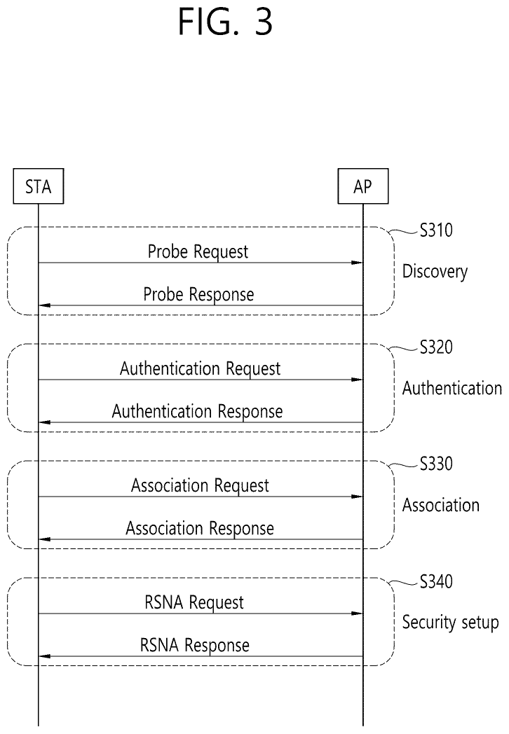

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

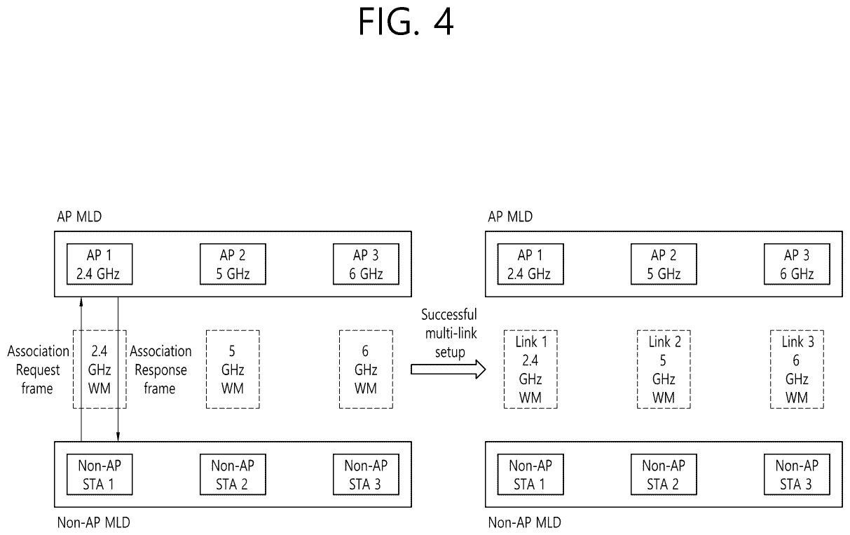

FIG. 4 shows an example of a multi-link (ML).

As illustrated in FIG. 4, multiple multi-link devices (MLDs) can perform communication via a remote link. The MLD can be classified into an AP MLD including multiple AP STAs and a non-AP MLD including multiple non-AP STAs. That is, the AP MLD can include affiliated APs (i.e., AP STAs), and the non-AP MLD can include affiliated STAs (i.e., non-AP STAs, or user-STAs).

The multi-link can include a first link and a second link, and different channels/subchannels/frequency resources can be allocated to the first and second links. The first and second multi-links can be identified through a link ID of 4 bits (or other n bits). The first and second links may be configured in the same 2.4 GHz, 5 GHz, or 6 GHz band. Alternatively, the first link and the second link may be configured in different bands.

The AP MLD of FIG. 4 includes three affiliated APs. In the example of FIG. 4, AP1 may operate in the 2.4 GHz band, AP2 may operate in the 5 GHz band, and AP3 may operate in the 6 GHz band. In the example of FIG. 4, the first link in which AP1 and non-AP1 operate may be defined as a channel/subchannel/frequency resource within the 2.4 GHz band. In addition, in the example of FIG. 4, the second link in which AP2 and non-AP2 operate may be defined as a channel/subchannel/frequency resource within the 5 GHz band. In addition, in the example of FIG. 4, the third link where AP3 and non-AP3 operate can be defined as a channel/subchannel/frequency resource within the 6 GHz band.

In the example of FIG. 4, AP1 can start a multi-link setup procedure (ML setup procedure) by transmitting an association request frame to non-AP STA1. In the example of FIG. 4, non-AP STA1 can transmit an association response frame in response to the association request frame. Each AP (e.g., AP1/2/3) illustrated in FIG. 4 may be identical to the AP illustrated in FIG. 1 and/or FIG. 2, and each non-AP (e.g., non-AP1/2/3) illustrated in FIG. 4 may be identical to the STA (i.e., user-STA or non-AP STA) illustrated in FIG. 1 and/or FIG. 2.

The specific features of the present disclosure are not limited to the specific features of FIG. 4. That is, the number of links can be defined in various ways, and multiple links can be defined in various ways within at least one band.

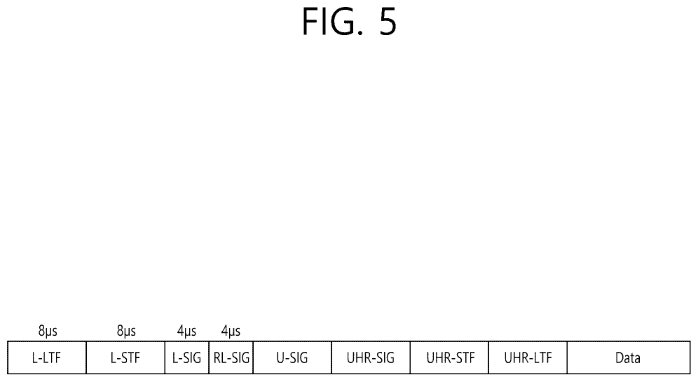

FIG. 5 shows an example of a physical protocol data unit or physical layer (PHY) protocol data unit (PPDU) transmitted/received by an STA of the present disclosure.

An STA (e.g., an AP STA, a non-AP STA, an AP MLD, a non-AP MLD) of the present disclosure can transmit and/or receive a PPDU of FIG. 5. The PPDU described in the present disclosure can have, for example, a structure of FIG. 5. In addition, the PPDU described in the present disclosure can be called by various names such as a transmission PPDU, a reception PPDU, a first type or an Nth type PPDU, etc. The PPDU described in the present disclosure can be used in a WLAN system defined according to IEEE 802.11bn and/or a next-generation WLAN system that improves IEEE 802.11bn.

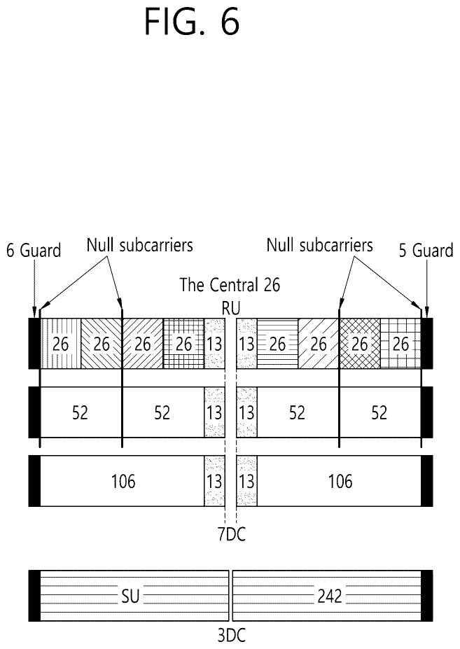

The PPDU of FIG. 5 can be related to various PPDU types used in a UHR system. For example, the example of FIG. 5 can be used for at least one of single-user (SU) mode/type/transmission, multi-user (MU) mode/type/transmission, and null-data packet (NDP) mode/type/transmission related to channel sounding. For example, if the example of FIG. 5 is related to NDP, the data field illustrated can be omitted. If the PPDU of FIG. 5 is used for trigger-based (TB) mode, UHR-SIG of FIG. 6 can be omitted. In other words, an STA that has received a trigger frame for uplink-MU (UL-MU) communication can transmit a PPDU with UHR-SIG omitted in the example of FIG. 5.

In FIG. 5, L-STF or UHR-LTF may be called a preamble or a physical preamble, and may be generated/transmitted/received/acquired/decoded in the physical layer (included in the transmitting/receiving STA).

Each block illustrated in FIG. 5 may be called a field/subfield/signal, etc. The names of these fields/subfields/signals may be legacy short training field (L-STF), legacy long training field (L-LTF), legacy signal (L-SIG), repeated L-SIG (RL-SIG), universal signal (U-SIG), UHR-signal (UHR-SIG), etc., as illustrated in FIG. 5.

A subcarrier spacing of the L-STF, L-LTF, L-SIG, RL-SIG, U-SIG, and UHR-SIG fields of FIG. 5 may be determined as 312.5 kHz, and a subcarrier spacing of the UHR-STF, UHR-LTF, and Data fields may be determined as 78.125 kHz. That is, a tone index (or subcarrier index) of the L-STF, L-LTF, L-SIG, RL-SIG, U-SIG, and UHR-SIG fields may be expressed in unit of 312.5 kHz, and a tone index (or subcarrier index) of the UHR-STF, UHR-LTF, and Data fields may be expressed in unit of 78.125 kHz.

In the PPDU of FIG. 5, the L-LTF and the L-STF may be the same as those in the conventional fields (for example, non-HT LTF and non-HT STF defined in conventional WLAN standards).

The L-SIG field of FIG. 5 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-high throughput (HT), high throughput (HT), very high throughput (VHT) PPDU, extremely high throughput (EHT) PPDU or UHR PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI, EHT PPDU or the UHR PPDU, the value of the length field may be determined as a multiple of 3, and for the high efficiency (HE) PPDU, the value of the length field may be determined as “a multiple of 3”+1 or “a multiple of 3”+2. In other words, the LENGTH field in an UHR PPDU is set to a value satisfying the condition that the remainder is zero when LENGTH is divided by 3

For example, the (non-AP and AP) STA may apply BCC encoding based on a 1/2 coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier {subcarrier index −21, −7, +7, +21} and a DC subcarrier {subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index {−28, −27, +27, +28}. The aforementioned signal may be used for channel estimation in the frequency domain corresponding to {−28, −27, +27, +28}.

For example, the (non-AP and AP) STA may generate an RL-SIG generated in the same manner as the L-SIG. BPSK modulation may be applied to the RL-SIG. The (non-AP and AP) STA may know that the RX PPDU is the HE PPDU, EHT PPDU, or the UHR PPDU, based on the presence of the RL-SIG. In other words, a receiving (non-AP and AP) STA can know that a received PPDU is one of a HE PPDU, an EHT PPDU, and a UHR PPDU if RL-SIG is present. In other words, a receiving (non-AP and AP) STA can know that a received PPDU is one of a non-HT PPDU, an HT PPDU, and a VHT PPDU if RL-SIG is not present. In other words, the RL-SIG field is a repeat of the L-SIG field and is used to differentiate a UHR PPDU from a non-HT PPDU, HT PPDU, and VHT PPDU.

A universal SIG (U-SIG) may be inserted after the RL-SIG of FIG. 6. The U-SIG may be called in various terms such as a first SIG field, a first SIG, a first type SIG, a control signal, a control signal field, a first (type) control signal, common control field, common control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 us. Each symbol of the U-SIG may be used to transmit the 26-bit information. For example, each symbol of the U-SIG may be transmitted/received based on 52 data tomes and 4 pilot tones.

Through the U-SIG for example, A-bit information (e.g., 52 un-coded bits) may be transmitted. A first symbol of the U-SIG may transmit first X-bit information (e.g., 26 un-coded bits) of the A-bit information, and a second symbol of the U-SIG may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, ‘000000’.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits (for example, 000 value) may indicate that the TX/RX PPDU is an EHT PPDU. Also, a second value of the PHY version identifier of 3 bits (for example, 001 value) may indicate that the TX/RX PPDU is a UHR PPDU.

In other words, when the (AP/non-AP) STA transmits an EHT PPDU, the 3-bit PHY version identifier can be set to the first value, and when the (AP/non-AP) STA transmits a UHR PPDU, the 3-bit PHY version identifier can be set to the second value. In other words, the receiving (AP/non-AP) STA can determine that the received PPDU is an EHT PPDU based on the PHY version identifier having the first value, and can determine that the received PPDU is a UHR PPDU based on the PHY version identifier having the second value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a transmission opportunity (TXOP) length and information related to a BSS color ID.

For example, if a UHR PPDU is classified into various types (e.g., type related to SU transmission (performed based on UL or DL), type related to DL transmission, type related to NDP transmission, type related to DL non-MU-MIMO, type related to DL MU-MIMO, type related to multi-AP operation, type related to coordinated beamforming (Co-BF), spatial reuse (SR), type related to coordinated OFDMA (C-OFDMA), type related to coordinated TDMA (Co-TDMA)), information about the type of the UHR PPDU (e.g., 2-bit or 3-bit information) can be included in the version-dependent bits of the U-SIG.

For example, the U-SIG may include: 1) a bandwidth field including information related to a bandwidth; 2) a field including information related to an modulation and coding scheme (MCS) applied to UHR-SIG; 3) an indication field including information regarding whether a dual subcarrier modulation (DCM) scheme is applied to UHR-SIG; 4) a field including information related to the number of symbol used for UHR-SIG; 5) a field including information regarding whether the UHR-SIG is generated across a full band; 6) a field including information related to a type of UHR-LTF/STF; and 7) information related to a field indicating an UHR-LTF length and a CP length.

Preamble puncturing may be applied to the PPDU of FIG. 5. The preamble puncturing implies that puncturing is applied to part (e.g., a secondary 20 MHz band) of the full band. For example, when an 80 MHz PPDU is transmitted, an STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80MHaz band within the 160 MHz band (or 80+80 MHz band).

Information related to the preamble puncturing applied to the PPDU may be included in U-SIG and/or UHR-SIG. For example, a first field of the U-SIG may include information related to a contiguous bandwidth, and second field of the U-SIG may include information related to the preamble puncturing applied to the PPDU.

For example, the U-SIG and the UHR-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an UHR-SIG contiguous to the first U-SIG may include information related to a preamble puncturing applied to the second 80 MHz band (i.e., information related to a preamble puncturing pattern), and an UHR-SIG contiguous to the second U-SIG may include information related to a preamble puncturing (i.e., information related to a preamble puncturing pattern) applied to the first 80 MHz band.

Additionally or alternatively, the U-SIG and the UHR-SIG may include the information related to the preamble puncturing, based on the following method. The U-SIG may include information related to a preamble puncturing (i.e., information related to a preamble puncturing pattern) for all bands. That is, the UHR-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The UHR-SIG of FIG. 5 may include control information for the receiving STA. The UHR-SIG may be transmitted through at least one symbol, and one symbol may have a length of 4 us. Information related to the number of symbols used for the UHR-SIG may be included in the U-SIG.

UHR-SIG provides an additional signal to the U-SIG field to enable STA to interpret/decode UHR PPDU. UHR-SIG field may include U-SIG overflow bits that are commonly applied to all users. In addition, UHR-SIG field includes resource allocation information, so that STA can look-up resources used in fields including data field/UHR-STF/UHR-LTF (i.e., UHR modulated fields of a UHR PPDU).

Frequency resources of UHR-LTF, UHR-STF, and data fields illustrated in FIG. 5 may be determined based on RUs (resource units) defined by multiple subcarriers/tones. That is, UHR-LTF, UHR-STF, and data fields of the present disclosure may be transmitted/received through RUs (resource units) defined by multiple subcarriers/tones.

FIG. 6 is a diagram illustrating the layout of resource units (RUs) used for a 20 MHz PPDU. That is, the UHR-LTF, UHR-STF, and/or data fields included in the 20 MHz PPDU may be transmitted/received through at least one of the various RUs defined in FIG. 6.

As illustrated in the uppermost part of FIG. 6, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

Meanwhile, the layout of the RUs in FIG. 6 may be used not only for a multiple users (MUs) but also for a single user (SU), in which case one 242-unit may be used and three DC tones may be inserted as illustrated in the lowermost part of FIG. 6.

Although FIG. 6 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones). In this specification, N-RU may be represented as N-tone RU, etc. For example, 26-RU may be represented as 26-tone RU.

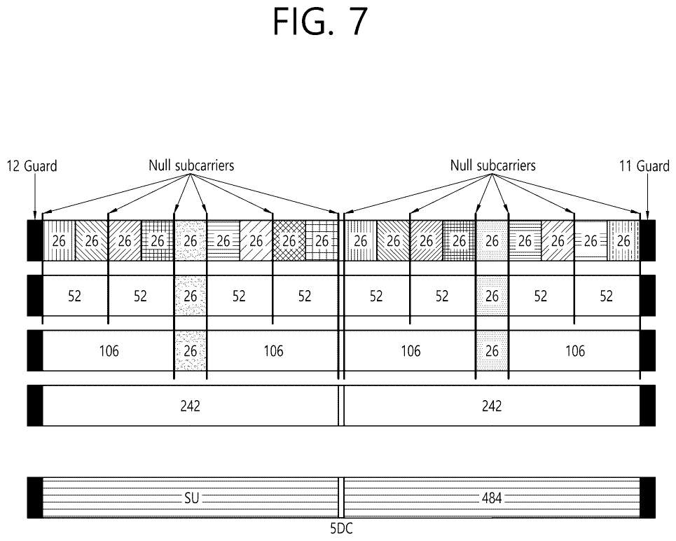

FIG. 7 is a diagram illustrating the layout of resource units (RUs) used for 40 MHz PPDU.

Similarly to FIG. 6 in which RUs having various sizes are used, a 26-RU, a 52-RU, a 106-RU, a 242-RU, a 484-RU, and the like may be used in an example of FIG. 7. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 7, when the layout of the RUs is used for a single user, a 484-RU may be used. The specific number of RUs may be changed similarly to FIG. 6.

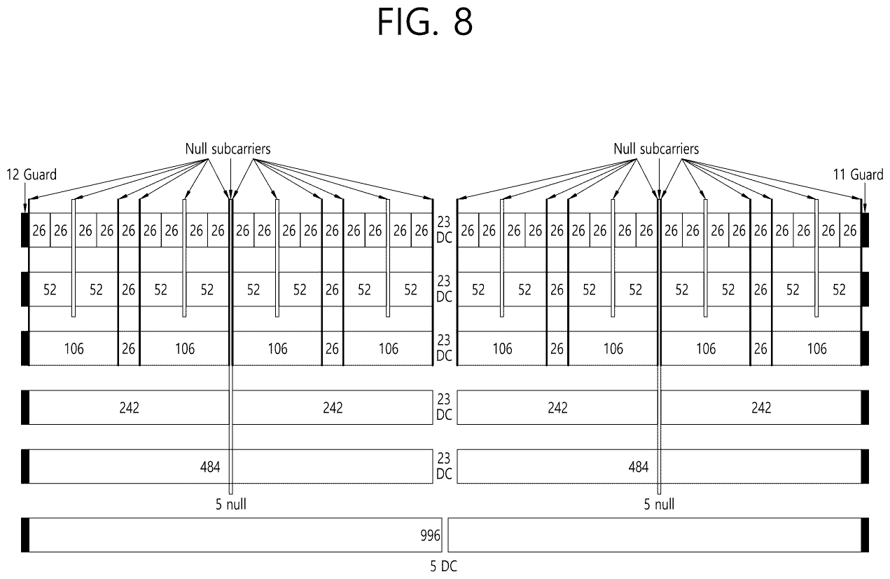

FIG. 8 is a diagram illustrating the layout of resource units (RUs) used for an 80 MHz PPDU. The layout of resource units (RUs) used in this specification may vary. For example, the layout of resource units (RUs) used in the 80 MHz band may vary.

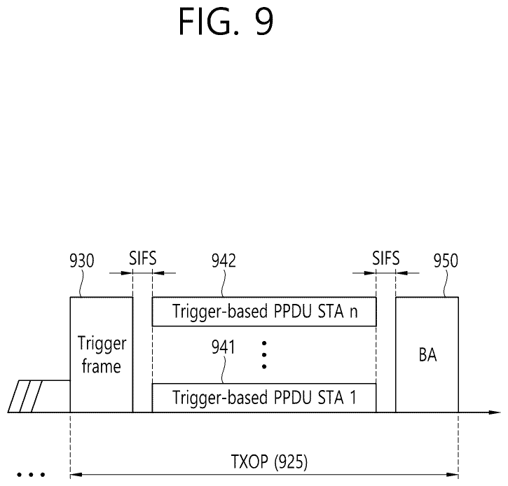

FIG. 9 shows an operation related to UL-MU. As illustrated, a transmitting STA (e.g., AP) can perform channel access through contending (i.e., backoff operation) and transmit a trigger frame (930). That is, the transmitting STA (e.g., AP) can transmit a PPDU including a trigger frame (930). When a PPDU including a trigger frame is received, a TB (trigger-based) PPDU is transmitted after a delay of SIFS.

TB PPDUs (941, 942) are transmitted at the same time and can be transmitted from multiple STAs (e.g., User STAs) whose AIDs are indicated in the Trigger frame (930). The ACK frame (950) for the TB PPDU can be implemented in various forms.

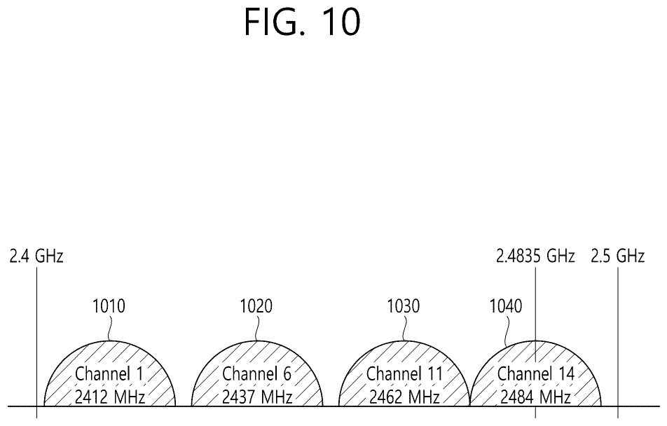

FIG. 10 illustrates an example of channels used/supported/defined within the 2.4 GHz band.

The 2.4 GHz band may also be referred to by other names, such as “first band.” Furthermore, the 2.4 GHz band may refer to a frequency range in which channels with center frequencies adjacent to 2.4 GHz (e.g., channels with center frequencies between 2.4 and 2.5 GHz) are used/supported/defined.

The 2.4 GHz band may include multiple 20 MHz channels. The 20 MHz within the 2.4 GHz band may have multiple channel indices (e.g., indices 1 through 14). For example, the center frequency of a 20 MHz channel assigned channel index 1 may be 2.412 GHz, the center frequency of a 20 MHz channel assigned channel index 2 may be 2.417 GHz, and the center frequency of a 20 MHz channel assigned channel index N may be (2.407+0.005*N) GHz. The channel indices may be referred to by various names, such as channel numbers. The specific numerical values of the channel indices and center frequencies may change.

FIG. 10 exemplarily illustrates four channels within the 2.4 GHz band. The illustrated first frequency region (1010) to fourth frequency region (1040) may each include one channel. For example, the first frequency region (1010) may include channel 1 (a 20 MHz channel having an index of 1). In this case, the center frequency of channel 1 may be set to 2412 MHz. The second frequency region (1020) may include channel 6. In this case, the center frequency of channel 6 may be set to 2437 MHz. The third frequency region (1030) may include channel 11. In this case, the center frequency of channel 11 may be set to 2462 MHz. The fourth frequency region (1040) may include channel 14. In this case, the center frequency of channel 14 may be set to 2484 MHz.

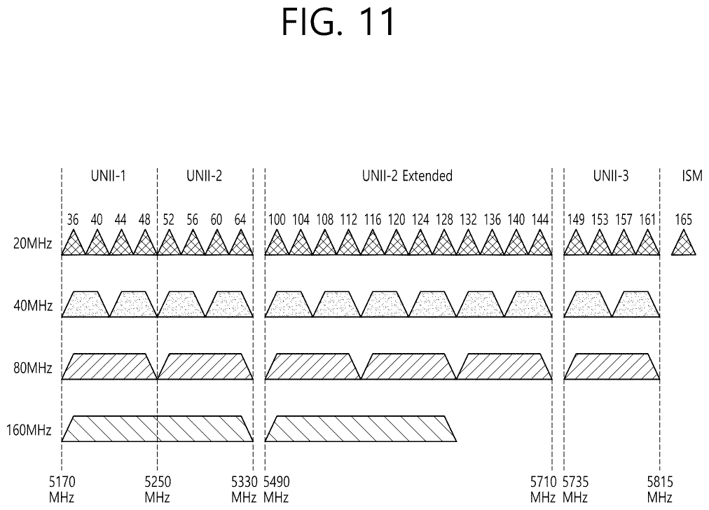

FIG. 11 illustrates an example of channels used/supported/defined within the 5 GHz band.

The 5 GHz band may be referred to by other names, such as a second band/band, etc. The 5 GHz band may refer to a frequency range in which channels with center frequencies greater than or equal to 5 GHz and less than 6 GHz (or less than 5.9 GHz) are used/supported/defined. Alternatively, the 5 GHz band may include multiple channels between 4.5 GHz and 5.5 GHz. The specific figures shown in FIG. 11 are subject to change.

Multiple channels within the 5 GHz band include Unlicensed National Information Infrastructure (UNII)-1, UNII-2, UNII-3, and ISM. UNII-1 may be referred to as UNII Low. UNII-2 may include frequency ranges called UNII Mid and UNII-2Extended. UNII-3 may be referred to as UNII-Upper.

Within the 5 GHz band, multiple channels can be configured, and the bandwidth of each channel can be variously configured, such as 20 MHz, 40 MHz, 80 MHz, or 160 MHz. For example, the 5170 MHz to 5330 MHz frequency domain/range within UNII-1 and UNII-2 can be divided into eight 20 MHz channels. The 5170 MHz to 5330 MHz frequency domain/range can be divided into four channels through a 40 MHz frequency domain. The 5170 MHz to 5330 MHz frequency domain/range can be divided into two channels through an 80 MHz frequency domain. Alternatively, the 5170 MHz to 5330 MHz frequency domain/range can be divided into one channel through a 160 MHz frequency domain.

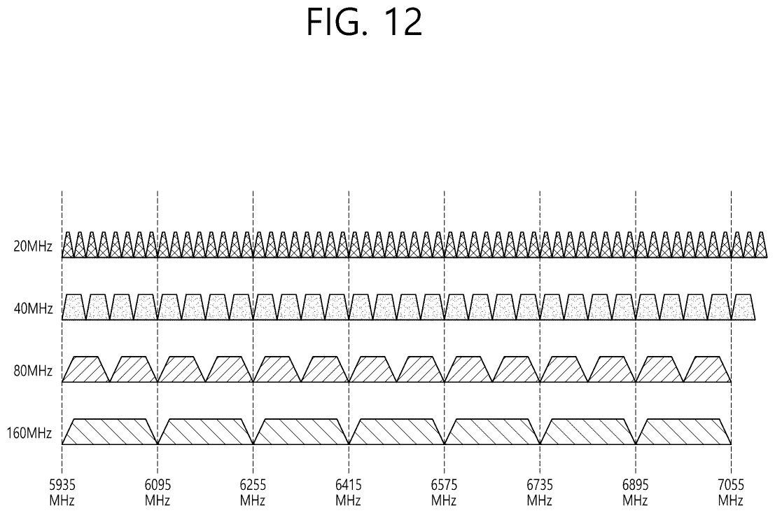

FIG. 12 illustrates an example of channels used/supported/defined within the 6 GHz band.

The 6 GHz band may be referred to by other names, such as the third band/band. The 6 GHz band may refer to a frequency range where channels with center frequencies higher than 5.9 GHz are used, supported, and defined. The specific values shown in FIG. 12 are subject to change.

For example, the 20 MHz channel in FIG. 12 may be defined starting from 5.940 GHz. Specifically, the leftmost channel among the 20 MHz channels in FIG. 12 may have an index of l (or channel index, channel number, etc.) and be assigned a center frequency of 5.945 GHz. In other words, the center frequency of channel index N may be determined as (5.940+0.005*N) GHz.

Accordingly, the indexes (or channel numbers) of the 20 MHz channels of FIG. 12 may be 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. Also, according to the (5.940+0.005*N) GHz rule mentioned above, the indexes of the 40 MHz channels in FIG. 12 may be 3, 11, 19, 27, 35, 43, 51, 59, 67, 75, 83, 91, 99, 107, 115, 123, 131, 139, 147, 155, 163, 171, 179, 187, 195, 203, 211, 219, 227.

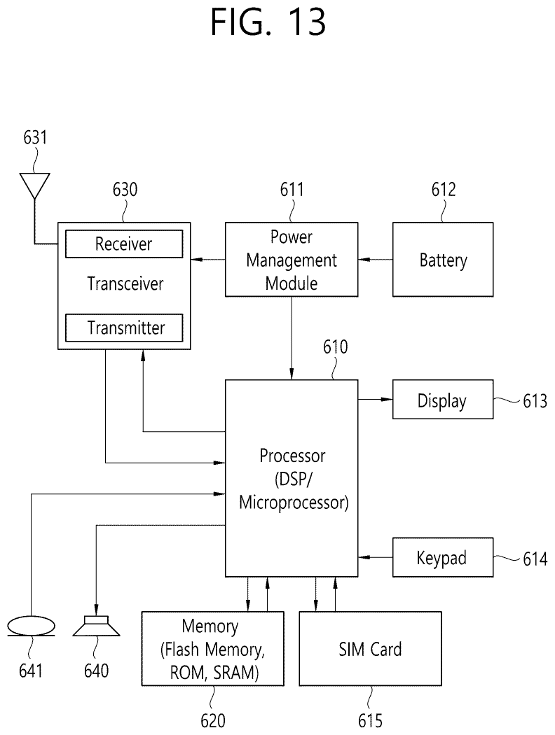

FIG. 13 shows a modified example of a transmitting device and/or a receiving device of the present disclosure.

The devices (e.g., AP STA, non-AP STA) shown in FIGS. 1 to 4 can be modified as shown in FIG. 13. The transceiver 630 of FIG. 13 can be identical to the transceiver 113, 123 of FIG. 1. The transceiver 630 of FIG. 13 can include a receiver and a transmitter.

The processor 610 of FIG. 13 can be identical to the processor 111, 121 of FIG. 1. Alternatively, the processor 610 of FIG. 13 can be identical to the processing chip 114, 124 of FIG. 1.

The memory 150 of FIG. 13 may be the same as the memory 112, 122 of FIG. 1. Alternatively, the memory 150 of FIG. 13 may be a separate external memory different from the memory 112, 122 of FIG. 1.

Referring to FIG. 13, the power management module 611 manages power for the processor 610 and/or the transceiver 630. The battery 612 supplies power to the power management module 611. The display 613 outputs the result processed by the processor 610. The keypad 614 receives input to be used by the processor 610. The keypad 614 may be displayed on the display 613. The SIM card 615 may be an integrated circuit used to securely store an international mobile subscriber identity (IMSI) and its associated keys, which are used to identify and authenticate subscribers in mobile devices such as mobile phones and computers.

Referring to FIG. 13, the speaker (640) may output sound-related results processed by the processor 610. The microphone (641) may receive sound-related input to be used by the processor 610.

Below, the Multi-AP operation applied to this specification is described.

The Multi-AP operation refers to a communication technique involving multiple APs in a WLAN. For example, the Multi-AP operation may refer to an operation in which one or more APs transmit and receive information to one or more STAs. In contrast to the Multi-AP operation, existing techniques may be expressed using various terms, such as STX (Single Transmission). For example, the STX operation may refer to a method in which one BSS AP communicates with one BSS STA. When communication is performed based on the STX operation, interference with adjacent APs (e.g., APs located in an overlapping BSS) may occur. This interference may result in reduced transmission and reception performance for cell-edge users (e.g., non-AP STAs located at the edge of the BSS).

FIG. 14 illustrates operation according to a conventional STX operation. As shown, adjacent AP1 and AP2 can cause interference between STAs and APs.

To improve the STX operation, a new multi-AP operation is proposed. This multi-AP operation can be based on a technology that reduces various interferences, such as inter-symbol interference (ISI), through coordination with neighboring APs (e.g., APs located in an overlapping BSS).

In FIG. 14, STA1 and AP1 may be included in a BSS, and STA2 and AP2 may be included in an OBSS (Overlapping Basic Service Set). That is, STA2 may be an unassociated STA to AP1, and STA1 may be an unassociated STA to AP2.

For example, the Multi-AP operation can be classified into various technologies/types/formats/protocols, etc. For example, the Multi-AP operation can include Coordinated TDMA (C-TDMA) that distinguishes wireless resources allocated to multiple APs based on a time axis (time domain). Additionally or alternatively, the Multi-AP operation can include Coordinated OFDMA (C-OFDMA) that distinguishes wireless resources allocated to multiple APs based on a frequency axis (time domain). Additionally or alternatively, the Multi-AP operation can include Coordinated Spatial Reuse (C-SR) that applies Spatial Reuse (SR) to at least one AP. Additionally or alternatively, the Multi-AP operation can include Coordinated beamforming (CBF)/nulling that nulls and transmits interference generated from neighbors (e.g., adjacent APs/STAs, and/or OBSS APs/OBSS STAs). Additionally or alternatively, the Multi-AP operation may include AP selection in which an AP with a good channel condition among neighboring APs (e.g., at least one AP located within a BSS or OBSS and with a good channel condition) transmits. Additionally or alternatively, the Multi-AP operation may include Joint Transmission (JTX) or JT in which multiple APs (e.g., multiple APs included in the same BSS/OBSS, or multiple APs included in different BSS/OBSS) cooperate to perform simultaneous transmission and reception, and JTX/JT may be implemented based on Joint Beamforming or Joint MU-MIMO.

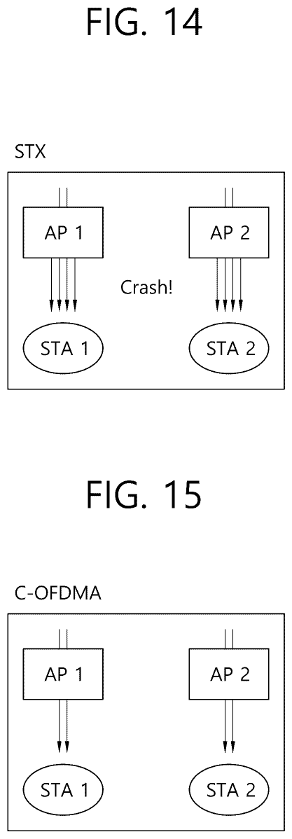

FIG. 15 illustrates an example of Coordinated OFDMA (C-OFDMA). The illustrated AP1 can transmit a PPDU/signal to STA1, and AP2 can transmit a PPDU/signal to STA2. The transmission from AP1 and the transmission from AP2 can be performed in the same/overlapping time interval. The transmission from AP1 to STA1 can be performed based on a first frequency band, and the transmission from AP2 to STA2 can be performed based on a second frequency band different from the second frequency band. For example, in FIG. 15, STA1 and AP1 can be included in a BSS, and STA2 and AP2 can be included in an OBSS. That is, STA2 can be an unassociated STA to AP1, and STA1 can be an unassociated STA to AP2.

Although not illustrated in FIG. 15, an example of Coordinated TDMA (C-TDMA) is also possible. For example, the acquired TXOP can be divided into specific time units (e.g., slots), and the divided slots can be sequentially assigned to multiple different APs.

The above-described C-OFDMA example can be further modified as follows. For example, an AP (e.g., AP1) that has acquired a TXOP can share frequency resources with at least one neighboring AP (e.g., AP2 in the BSS/OBSS). For example, shared frequency resources can be defined on a resource unit (RU) basis or a subchannel basis. For example, for flexibility, frequency resources can be shared from AP1 to AP2 in 20/40/80 MHz subchannels or 242/484/996-tone RU units.

AP1, performing C-OFDMA, can act as a sharing AP or a master AP. That is, AP1 can request at least one neighboring AP (e.g., AP2 in the BSS/OBSS) to report information about the channel and/or buffer status. Based on this, AP1 can obtain a TXOP and share a part of the frequency resource (e.g., a 20 MHz subchannel or a RU of a certain size) with at least one AP in the vicinity (e.g., AP2 existing in the BSS/OBSS) within all or part of the time interval related to the TXOP.

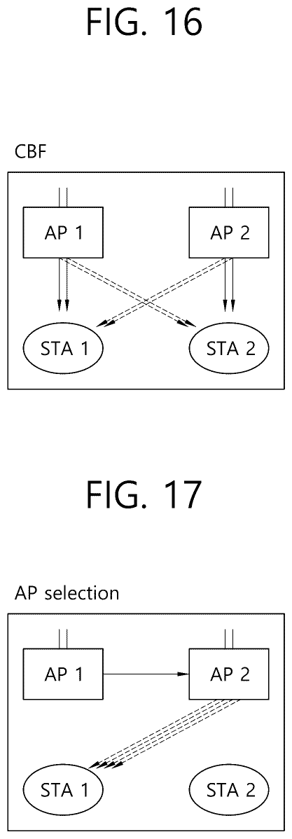

FIG. 16 illustrates an example of Coordinated Beamforming (CBF). The illustrated AP1 may transmit a PPDU/signal to STA1, and AP2 may transmit a PPDU/signal to STA2. The transmission from AP1 and the transmission from AP2 may be performed in the same/overlapping time interval. The transmission from AP1 and the transmission from AP2 may be performed through the same/overlapping frequency band. In order to reduce interference caused to STA2 by AP1, AP1 may perform nulling/beamforming toward STA2, and in order to reduce interference caused to STA1 by AP2, AP2 may perform nulling/beamforming toward STA1. For example, such nulling/beamforming may be implemented in a manner of positioning a radiation null to a neighboring unassociated STA. The above-described nulling/beamforming may make a specific AP invisible to a neighboring unassociated STA. For example, the above-described nulling/beamforming may make AP1 (or AP2) invisible to STA2 (or STA1).

For example, in FIG. 16, STA1 and AP1 may be included in the BSS, while STA2 and AP2 may be included in the OBSS. In other words, STA2 may be an unassociated STA to AP1, and STA1 may be an unassociated STA to AP2.

Although not illustrated in FIG. 16, control signals (e.g., coordination frames) for nulling/beamforming between AP1 and STA2 and/or nulling/beamforming between AP2 and STA1 may be transmitted and received over the backhaul link between AP1 and AP2.

FIG. 17 illustrates an example of AP selection. The illustrated AP2 is judged to have a better channel condition than AP1. AP1 transmits its data/signal to AP2 via a backhaul link, and AP2 can transmit a signal to STA1 instead of AP1. For example, in FIG. 17, STA1 and AP1 may be included in a BSS, and STA2 and AP2 may be included in an OBSS. In other words, STA2 may be an unassociated STA to AP1, and STA1 may be an unassociated STA to AP2.

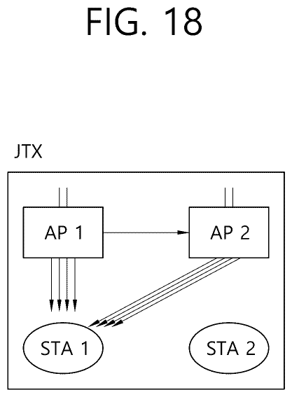

FIG. 18 illustrates an example of JTX/JT. The illustrated AP1 can transmit to STA1 together with AP2. For example, the PPDU/signal transmitted from AP2 to STA1 may be all or part of the same as the PPDU/signal transmitted from AP1 to STA1. For example, the PPDU/signal transmitted from AP2 to STA1 may be simultaneously transmitted through the same/overlapping frequency band as the PPDU/signal transmitted from AP1 to STA1. For example, the PPDU/signal transmitted from AP2 to STA1 may be a signal transmitted from AP1 through a backhaul link. For example, in FIG. 18, STA1 and AP1 may be included in a BSS, and STA2 and AP2 may be included in an OBSS. That is, STA2 may be an unassociated STA to AP1, and STA1 may be an unassociated STA to AP2.

More specifically, in FIG. 18, AP1 can transmit a coordination request (or can be named variously, such as a first request, a control request, etc.) to AP2 and receive a coordination response (or can be named variously, such as a first response, a control response, etc.) from AP2. Through the exchange of the request/response, information about coordination between AP1 and AP2 (e.g., information about whether AP1 and AP2 will perform simultaneous transmission to STA1), information about the point in time when coordination starts, information about the point in time when AP1 and AP2 start simultaneous transmission to STA1, information about data shared between AP1 and AP2, etc. can be exchanged. AP1 can share its data with AP2 via the backhaul link. Thereafter, AP1 can transmit a coordination trigger frame (or can be named variously, such as a trigger frame) to AP2 and perform simultaneous transmission to STA1 based on the trigger frame.

### Embodiments Applicable to this Specification

To enable terminals to maintain continuous WLAN connectivity over a wider area, numerous APs are being installed adjacent to each other. However, overlapping BSSs of multiple APs can lead to issues such as radio interference and transmission collisions between APs. To address these issues, various technologies have been proposed to coordinate APs across frequency, time, and spatial domains (e.g., RU selection, joint transmission, nulling, etc.). Furthermore, attention should be paid to the various issues that may arise during inter-AP coordination.

In EHT (802.11be), a technology was proposed to allocate some time within the TXOP acquired by the AP to support peer-to-peer (P2P) transmission to non-AP STAs. To this end, a new TXOP Sharing Mode subfield was defined in the Common Info field of the existing MU-RTS Trigger frame, and the MU-RTS (Multi User-Request To Send) Trigger frame when this value is nonzero is referred to as an MU-RTS TXOP Sharing (TXS) Trigger frame (TF). If the value of the TXOP Sharing mode is 1, the non-AP STA supports one or more (non-TB) PPDU transmissions to the AP, and if the value of the TXOP Sharing mode is 2, the non-AP STA supports P2P transmission in addition to (non-TB) PPDU transmissions to the AP.

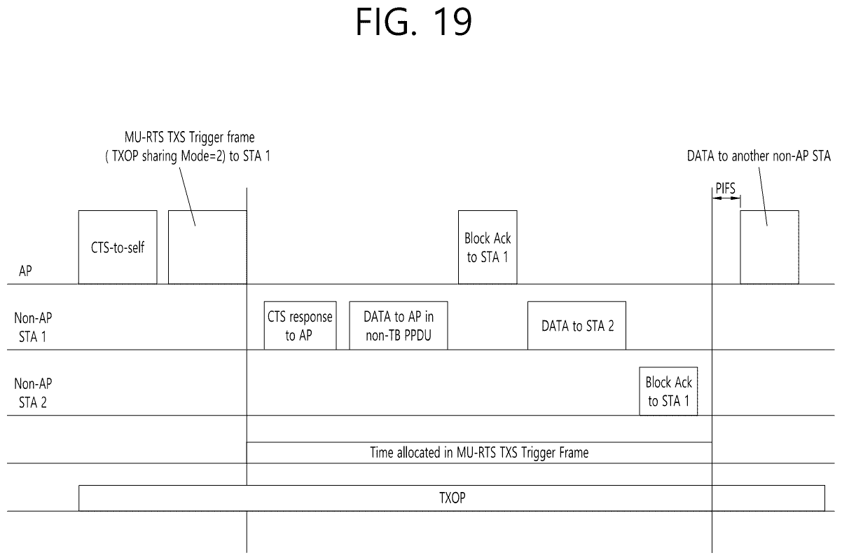

FIG. 19 illustrates an example of the operation of an MU-RTS TXS trigger frame in which the TXOP Sharing Mode subfield value is 2.

FIG. 19 shows an example of operation when the TXOP Sharing mode value is 2. When the AP transmits an MU-RTS TXS TF including time allocation information (Time allocated in MU-RTS TXS Trigger Frame of FIG. 19) to non-AP STA 1, non-AP STA 1 can perform P2P transmission to non-AP STA 2 after responding with Clear-To-Send (CTS).

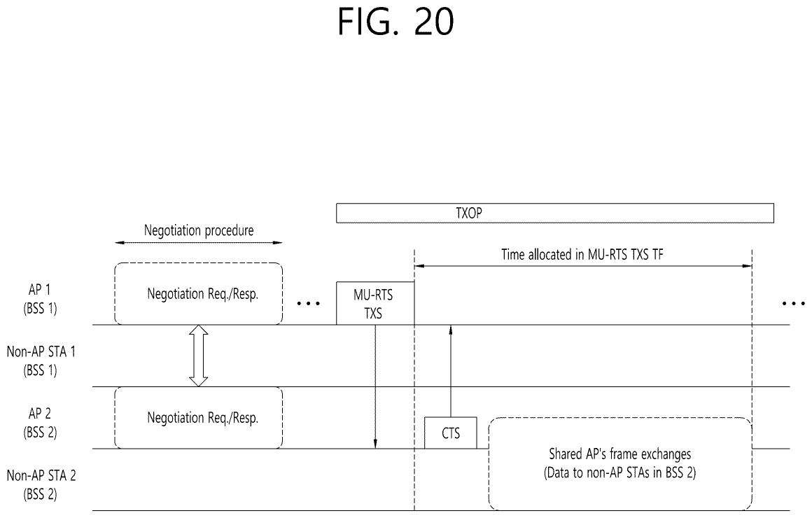

FIG. 20 illustrates an example of coordinated TDMA operation, including a negotiation process.

Meanwhile, if the existing Triggered TXOP Sharing protocol is utilized for multi-AP coordination, frame exchange can be performed without affecting each other by dividing the transmission within the BSS of each cooperative AP by time unit. That is, FIG. 20 shows an example of Coordinated-Time Division Multiplexing Access (Co-TDMA) according to the time unit among the coordination methods between cooperative APs. At this time, the AP in the existing Triggered TXS protocol can play the role of an AP that shares TXOP in the multi-AP coordination operation, and the STA in the existing Triggered TXS protocol can play the role of an AP that shares TXOP in the multi-AP coordination operation. In this specification, an AP that shares TXOP is referred to as a Sharing AP (SAP), and an AP that receives TXOP from an SAP is referred to as a Shared AP (DAP). Here, the SAP that shares TXOP is not limited to only AP STAs, and may also include non-AP STAs that share TXOP. In addition, the DAP that shares TXOP is not limited to only AP STAs, and may also include non-AP STAs that share TXOP (or transmit and receive with AP STAs that share TXOP). In addition, the frame exchange with non-AP STAs or SAPs belonging to the DAP BSS during the time allocated to the DAP is referred to as the BSS frame exchange (FE) of the DAP. For example, the frame exchange may include data frame transmission and block ACK frame response following RTS/CTS frame exchange between the DAP and non-AP STAs, UL data frame transmission by non-AP STAs in response to a trigger frame transmitted from the DAP, or data frame transmission by the DAP in response to a trigger frame transmitted from the SAP.

Basically, in order for Multi-AP coordination to occur between two APs or for a Multi-AP organization (or peer) to be formed, each party must first exchange their capabilities and requirements (negotiation), and then an agreement must be reached based on the obtained information, through which Multi-AP coordination-based technologies (e.g., C-TDMA, C-BF, C-SR, etc.) can be implemented. On the other hand, if a specific AP that has established Multi-AP coordination no longer wishes to maintain Multi-AP coordination due to the purpose of power saving or various other factors, a procedure to teardown Multi-AP coordination needs to be performed.

Therefore, this specification defines and proposes a frame that an AP that has established multi-AP coordination transmits to terminate the multi-AP coordination. The MAP (or MAPC) teardown frame (tentative name) proposed in this specification allows an AP that has established multi-AP coordination to teardown the multi-AP coordination.

To clarify the terminology, the cooperative relationship can be referred to as a Multi-AP Coordination (MAPC) relationship or MAPC agreement. The AP that initiates the MAPC (or MAPC negotiation for at least one MAPC technique) can be referred to as a MAPC requesting AP or coordinating AP. The AP that responds to the MAPC requesting AP can be referred to as a MAPC responding AP or coordinated AP. The coordinating AP is an AP that shares a portion of the transmission opportunity (TXOP) resources with the coordinated AP by allocating a portion of the time or allowing simultaneous transmission as part of the MAPC procedure.

The specific designations (names) proposed in this specification may be changed and are not limited to any one.

Through the Coordinated TDMA (Co-TDMA) procedure, an AP can share the time portion of the acquired TXOP with other APs in the AP set (which may consist of a single AP) to transmit at least one PPDU.

The Co-TDMA procedure includes a polling phase, a TXOP allocation phase, and a TXOP return phase.

In the polling phase, a Co-TDMA shared AP can request a poll response transmitted as a TB PPDU from other APs only if the other APs support the response as a TB PPDU. The Co-TDMA shared AP notifies its intention to share the time portion of the TXOP acquired from the Initial Control Frame (ICF) transmitted at the start of the TXOP with other APs. When the ICF receives a time allocation from a Co-TDMA shared AP within the TXOP, it polls one or more APs to request a response in order to determine the intention of the polled AP. The Duration field of the ICF is set to a value equal to one SIFS plus the time required to transmit the requested response from the polled AP. When the ICF polls to determine the intention of the AP in case of receiving a time allocation from a Co-TDMA shared AP within the TXOP, the ICF is a trigger frame. The Co-TDMA shared AP identifies each AP to be polled by setting the AID12 subfield of the user information field of the polled AP to the AP ID of the polled AP in the trigger frame.

The polled AP responds to the received ICF by providing:
Indicating that it will not receive time allocations from the Co-TDMA shared AP during the current TXOP (Note that if the Co-TDMA shared AP does not receive a response from the polled AP, the Co-TDMA shared AP indicates that it will not receive time allocations from the Co-TDMA shared AP during the current TXOP).
Indicating that it will receive time allocations from the Co-TDMA shared AP during the current TXOP.
Signaling details (including traffic indications).

In the TXOP allocation phase, a Co-TDMA shared AP can allocate a portion of the time within the acquired TXOP to other APs that are not collocated with the Co-TDMA shared AP. To share the time portion of the acquired TXOP, the AP must transmit an MU-RTS TXS trigger frame to other APs that are not collocated with the Co-TDMA shared AP.

The Duration field of the MU-RTS TXS trigger frame is set to a value equal to one SIFS plus the time required to transmit the requested CTS response frame. The Co-TDMA shared AP identifies the Co-TDMA coordinated AP with which it will share the time portion of the acquired TXOP by setting the AID12 subfield of the user information field of the MU-RTS TXS trigger frame to the AP ID of the Co-TDMA coordinated AP. When the Co-TDMA coordinated AP receives the MU-RTS TXS trigger frame from the Co-TDMA shared AP, the AP may transmit and/or receive one or more PPDUs within the time allocation indicated in the MU-RTS TXS trigger frame. The first PPDU of the exchange shall carry a CTS frame. The time allocated to the Co-TDMA coordinated AP identified in the MU-RTS TXS trigger frame is specified in the Allocation Duration subfield of the MU-RTS TXS trigger frame.

In the TXOP return phase, the Co-TDMA cooperating AP may return the remainder of its allocated time (if any) to the Co-TDMA sharing AP.

This specification defines and proposes a frame transmitted by an AP that has established Multi-AP Coordination (MAPC) to teardown the MAPC. The MAPC Teardown frame proposed in this specification for MAPC release can be defined and designed as presented in Section 1 below.

### 1. Multi-AP Coordination Teardown Frame Format

### 1.1. Definition of the Action Field Format of the MAPC Teardown Frame

An AP that has established a MAPC can transmit a newly defined MAPC Teardown frame to teardown the MAPC. The MAPC Teardown frame can be redefined as a (Public) Action frame, a type of Management frame. Since typical Management frames are relatively large, defining them as (Public) Action frames has the advantage of reducing frame size overhead.

Specifically, a new Public Action frame format for MAPC teardown may be defined using the Reserved values (e.g., 54-59, 61-255) of the Public Action field. Additionally or alternatively, a new Public Action frame format for overall MAPC operation may be defined and categorized and defined by the MAPC Type field (e.g., Discovery, Negotiation, and Teardown) of the MAPC element within the Management frame. Additionally or alternatively, a new Public Action frame format for overall MAPC operation may be defined and categorized first by the MAPC Type field (e.g., Discovery, Negotiation) of the MAPC element within the Management frame, and then categorized and defined as MAPC Teardown through the MAPC Operation Type field of the MAPC Negotiation frame.

In this specification, this is referred to as the MAPC Teardown frame, although the specific name is subject to change. The MAPC Teardown frame may include elements/fields containing common information for multi-AP coordination and/or elements/fields containing information for individual multi-AP coordination schemes (e.g., C-SR/BF/TDMA, etc.).

For example, the Action field format of the MAPC Teardown frame may be as shown in Table 1.

TABLE 1

| Order | Information | Notes |
|---|---|---|
| 1 | Category | The Category field is defined (Action field). |
| | | If the Public Action frame is assumed, indicate Code 4 |
| | | (Public). |
| 2 | Public Action | Indicates a value corresponding to the Public Action field |
| | | values - indicates that it is a MAPC Teardown frame format |
| | | for MAPC teardown using a reserved value (e.g., 54-59, |
| | | 61-255) |
| 3 | SSID (or AP ID, | For example, the SSID (MAC address) of the peer AP. |
| | Multi-AP ID) | Additionally or alternatively, the Multi-AP ID (or AP ID) |
| | | locally assigned/granted to the peer AP during the |
| | | negotiation procedure for Multi-AP coordination. |
| | | Additionally or alternatively, the Multi-AP ID (or AP ID) |
| | | locally assigned/granted from the peer AP during the |
| | | negotiation procedure for Multi-AP coordination. |
| 4 | Multi-AP | Multi-AP Coordination Management element containing |
| | Coordination | various management information utilized during the |
| | Management or | negotiation process for Multi-AP coordination or Multi-AP |
| | MAPC element | coordination operation. |

### 1.2. The Multi-AP Coordination Management Element (or MAPC Element) of the MAPC Teardown Frame Contains the Following Information:

The Multi-AP Coordination Management element (i.e., MAPC element) of the MAPC Teardown frame may contain information based on one or more combinations of the information presented below. The names of these contents may be changed, and new contents may be added, but this is not limited to the following.

A. Length: Indicates the number of octets in the element, excluding the Length field.

B. MAPC Protocol Identifier: Indicates the protocol type of the currently established Multi-AP coordination protocol.
For example, an unauthenticated Multi-AP coordination protocol
For example, an authenticated multi-AP coordination protocol

C. Link ID: Used to identify the link established or established for multi-AP coordination and indicates the multi-AP coordination link.

D. Reason Code: Reason information for the teardown of multi-AP coordination.

Specifically, the reason codes defined in the existing Reason Code field can be utilized.
For example, setting Reason code=1 (UNSPECIFIED_REASON) indicates that Multi-AP coordination is to be disabled due to an unspecified reason.
For example, setting Reason code=2 (INVALID_AUTHENTICATION) indicates that Multi-AP coordination is to be disabled because the previous authentication is no longer valid.
For example, setting Reason code=39 (TIMEOUT) indicates that Multi-AP coordination is to be disabled due to a timeout.

E. MAPC PMK: Contains/indicates the PMK identifier (PMKID) used to derive the PTK (Pairwise Transient Key: a dynamically generated temporary key valid for a single session) when configuring multi-AP coordination with neighboring APs. This identifies the PMK (Pairwise Master Key: a secret key shared between the AP and non-AP STAs) used to protect Management frames exchanged between APs.

For example, the Chosen PMK (optional) field within the existing Mesh Peering Management element can be used. The Chosen PMK field is present if dot11MeshSecurity Activated is true and the sender and receiver of the frame containing the element share a PMK. The Chosen PMK field includes the PMKID, which identifies the PMK used to protect Mesh Peering Management.

F. Address: Address information of the target AP (e.g., BSS color, BSSID for multi-AP, or MAC address)

G. MAPC group ID: ID for the group of APs that constitute MAPC (e.g., 0, 1, 2, . . . )

H. MAPC agreement ID: Indicates the individual ID for the multi-AP agreement (i.e., MAPC agreement ID).

I. AP ID: ID locally assigned by each AP within the configured multi-AP group/set (e.g., 0, 1, 2, . . . )

For example, the AP ID may be included in the AID12 field within the User Info field of the Trigger Frame (TF).

Additionally or alternatively, the AP ID may be included in the AID12 field of the UHR Special User Info field, which may be newly defined for UHR.

For example, the AP ID may be included in the AID11 field within the STA Info field of the UHR NDP Announcement frame.

L. MAPC Schemes Type: Indicates multi-AP cooperative transmission techniques such as Co-TDMA/SR/BF.

For example, a MAPC element may contain a MAPC Control field, a MAPC Common Info field, and a MAPC Schemes Info field. The MAPC Schemes Info field can distinguish MAPC schemes and contain separate information using a Subelement ID, which acts as a MAPC Type field.

For example, each bit can be signaled as follows:
0: Co-TDMA
1: Co-SR
2: Co-BF
. . .

For example, the bitmap can be signaled as follows:
B0: Co-TDMA
B1: Co-SR
B2: Co-BF
. . .

For example, a MAPC Scheme Type within a separate subelement for each scheme can be used to indicate the corresponding Multi-AP cooperative transmission scheme (e.g., Co-BF/SR/TDMA/RTWT) to perform teardown of the corresponding Multi-AP cooperative transmission.

That is, a single teardown frame can simultaneously perform teardown for more than one Multi-AP scheme, and profiles for more than one scheme can exist.

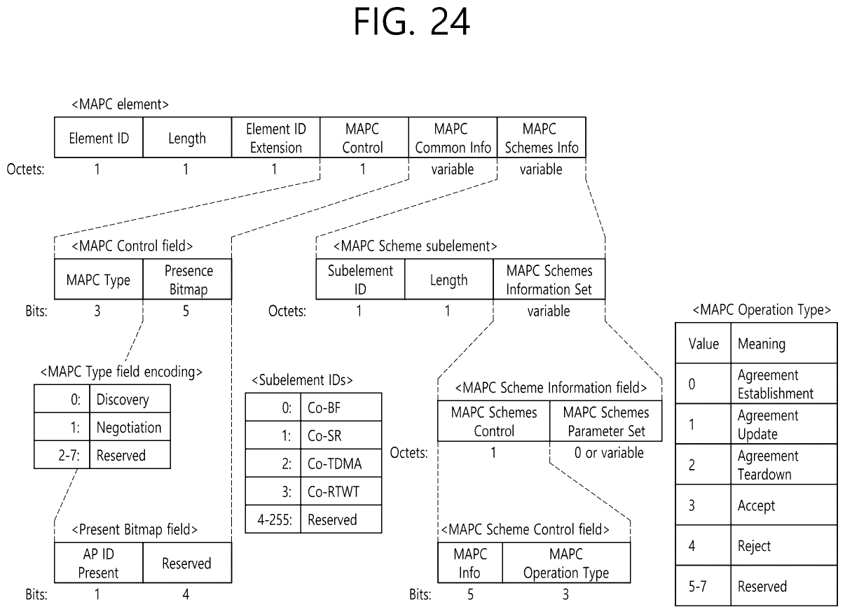

Specifically, the MAPC Scheme Info field in FIG. 24 can include a MAPC Schemes Type field instead of the Subelement ID field to indicate which scheme the subelement contains information about or for which scheme teardown is performed. In other words, the specific scheme of the subelement can be indicated through a separate MAPC Scheme Info field, rather than the Subelement ID field.

### 1.3 MAPC Element Structure

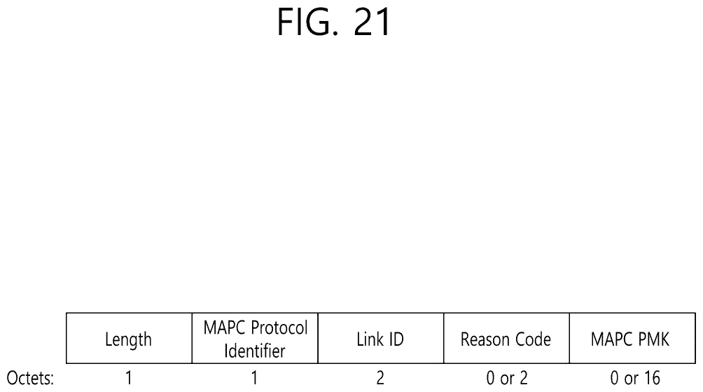

An example of a MAPC element format including one or more of the information presented above may be as shown in FIG. 21.

FIG. 21 illustrates an example of a MAPC element format.

Referring to FIG. 21, the MAPC element includes a Length field, a MAPC Protocol Identifier field, a Link ID field, a Reason Code field, and a MAPC PMK field.

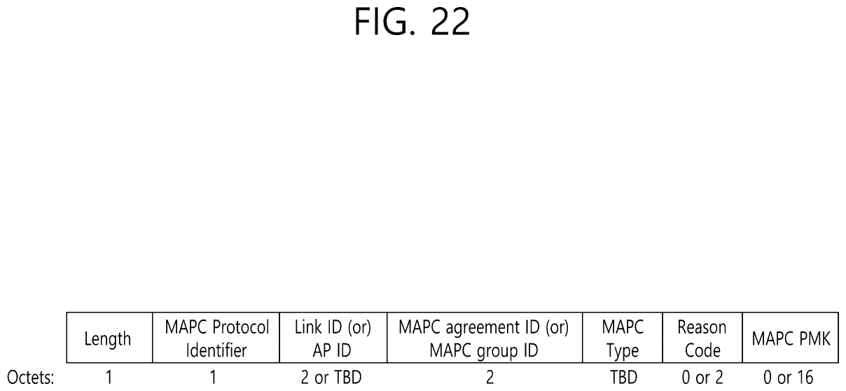

Additionally or alternatively, an example of a MAPC element format including a MAPC-related ID and Type may be as shown in FIG. 22.

FIG. 22 illustrates another example of a MAPC element format.

Referring to FIG. 22, the MAPC element includes a Length field, a MAPC Protocol Identifier field, a Link ID (or AP ID) field, a MAPC agreement ID (or MAPC group ID) field, a MAPC Type field, a Reason Code field, and a MAPC PMK field.

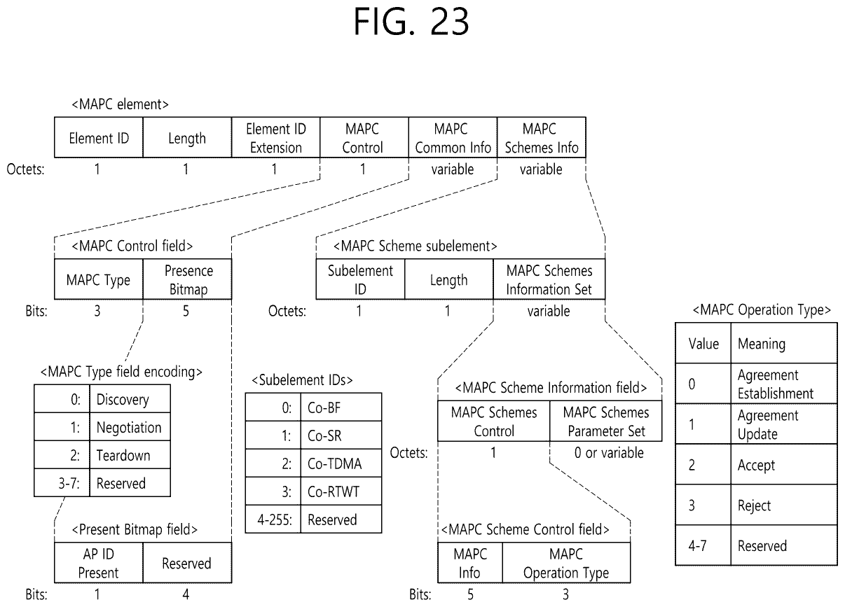

Additionally or alternatively, examples of a MAPC element format including a MAPC Control field, a MAPC Common Info field, and a MAPC Schemes Info field may be as shown in FIGS. 23 and 24.

FIG. 23 illustrates an example of a MAPC element format including a MAPC Control field, a MAPC Common Info field, and a MAPC Schemes Info field.

FIG. 23 shows an example of a MAPC element format in which separate MAPC Discovery, MAPC Negotiation, and MAPC Teardown frames can be defined by distinguishing Teardown as one of the MAPC Type fields within the MAPC Control field.

FIG. 24 illustrates another example of a MAPC element format including a MAPC Control field, a MAPC Common Info field, and a MAPC Schemes Info field.

On the other hand, FIG. 24 shows an example of a MAPC element format in which a MAPC Negotiation frame is transmitted for the purpose of a specific MAPC Operation Type (e.g., Teardown) by distinguishing Teardown as one of the MAPC Operation Types in the MAPC Scheme Control field in the MAPC Schemes Info field. The MAPC element of FIG. 24 has the advantage of being able to perform teardown individually for each MAPC scheme.

### 2. Multi-AP Coordination Teardown Processing

An AP that receives a MAPC Teardown frame must reject the MAPC Teardown frame if the value of the SSID (or AP ID, Multi-AP ID) element in the frame does not match its own SSID (or the AP ID, Multi-AP ID assigned by neighboring APs in a cooperative relationship). Otherwise, the AP must accept the MAPC Teardown frame and discard some or all of the information exchanged for Multi-AP coordination with the AP that transmitted the MAPC Teardown frame.

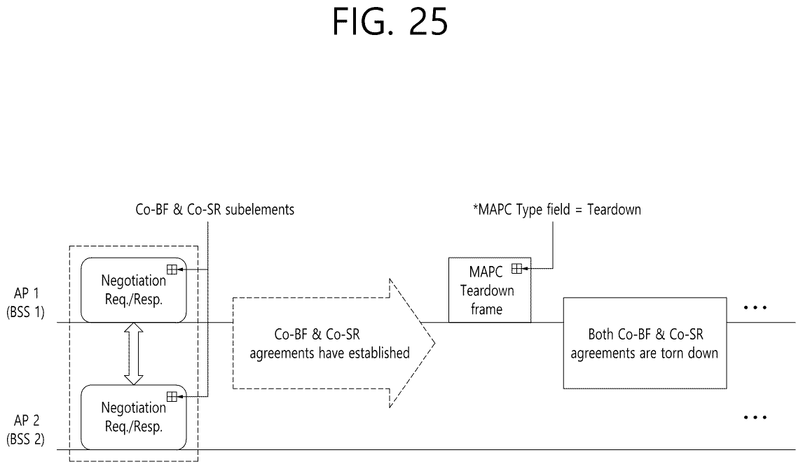

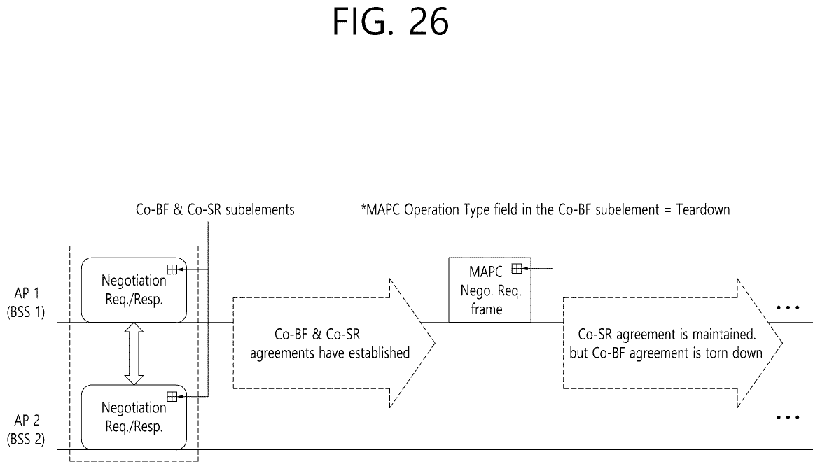

FIGS. 25 and 26 illustrate an embodiment of MAPC teardown based on FIGS. 23 and 24 presented in Section 1 above.

### 2.1. Example 1 of MAPC Teardown Operation

FIG. 25 illustrates an example of a MAPC teardown operation.

FIG. 25 illustrates an example where the MAPC Type field is directly indicated as Teardown, and an individual MAPC Teardown frame is transmitted. Upon receiving the MAPC Teardown frame, AP 2 tears down all MAPC scheme agreements previously established with AP 1.

### 2.2. Example 2 of MAPC Teardown Operation

FIG. 26 illustrates another example of a MAPC teardown operation.

On the other hand, FIG. 26 illustrates an example of transmitting a MAPC Negotiation Request frame for teardown purposes by setting the MAPC Operation Type field, which can be included in a subelement of a specific MAPC scheme, to Teardown. Upon receiving the MAPC Negotiation Request frame, AP 2 tears down only the agreement for the corresponding MAPC scheme (i.e., Co-BF in FIG. 26) and maintains the existing Co-SR agreement.

This specification defines and proposes a MAPC Teardown frame transmitted by an AP that has established multi-AP coordination to teardown multi-AP coordination. Through the MAPC Teardown frame (tentative name) proposed in this specification, an AP that has established multi-AP coordination can terminate multi-AP coordination with a target AP.

In multi-AP coordination, a Management frame (or Action frame, Public Action frame, or MAPC Teardown frame) for teardown purposes can belong to the Management frame.

A description of Multi-AP Coordination (MAPC) follows.

MAPC is a framework in which multiple APs cooperate to reduce interference, improve channel utilization efficiency, and improve reliability and delay. Its main schemes include Coordinated Beamforming (Co-BF), Coordinated Spatial Reuse (Co-SR), Coordinated TDMA (Co-TDMA), Coordinated Restricted Target Wake Time (Co-RTWT), and Coordinated Channel Reservation (Co-CR).

Common MAPC procedures include the MAPC Discovery procedure and the MAPC Agreement Negotiation procedure. In the MAPC Discovery procedure, an AP can inform other APs of its MAPC capabilities and parameters via MAPC Discovery Request/Response frames or management frames. The MAPC Agreement Negotiation procedure can negotiate, establish, update, or teardown an agreement between APs regarding a specific MAPC scheme. Detailed MAPC agreement procedures can include establishing a MAPC agreement, assigning an AP ID to identify cooperating APs, updating parameters of an existing MAPC agreement, and performing the teardown of the MAPC agreement.

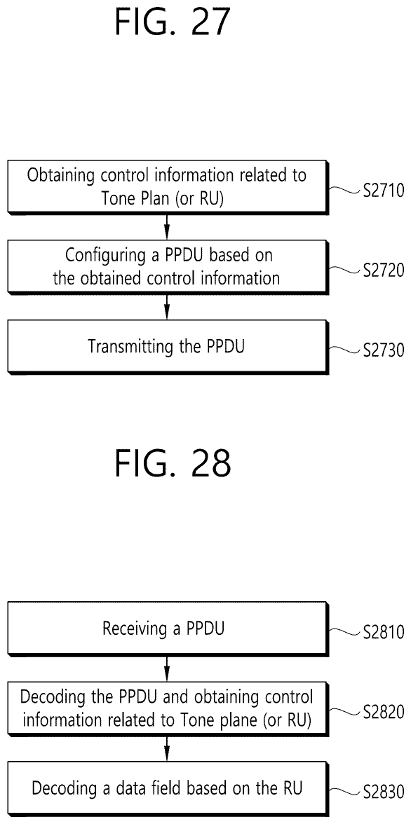

FIG. 27 is a flowchart illustrating the operation of a transmitting device according to the present embodiment.

The example of FIG. 27 may be performed by a transmitting device (AP and/or non-AP STA).

Some of each step (or detailed sub-step to be described later) of the example of FIG. 27 may be skipped/omitted.

Through step S2710, the transmitting device (transmitting STA) may obtain information about the above-described tone plan. As described above, the information about the tone plan includes the size and location of the RU, control information related to the RU, information about a frequency band including the RU, information about an STA receiving the RU, and the like.

Through step S2720, the transmitting device may construct/generate a PPDU based on the acquired control information. Configuring/generating the PPDU may include configuring/generating each field of the PPDU. That is, step S2720 includes configuring the EHT-SIG field including control information about the tone plan. That is, step S2720 includes configuring a field including control information (e.g., N bitmap) indicating the size/position of the RU; and/or configuring a field including an identifier of an STA receiving the RU (e.g., AID).

Also, step S2720 may include generating an STF/LTF sequence transmitted through a specific RU. The STF/LTF sequence may be generated based on a preset STF generation sequence/LTF generation sequence.

Also, step S2720 may include generating a data field (i.e., MPDU) transmitted through a specific RU.

The transmitting device may transmit the PPDU constructed through step S2720 to the receiving device based on step S2730.

While performing step S2730, the transmitting device may perform at least one of operations such as CSD, Spatial Mapping, IDFT/IFFT operation, and GI insertion.

A signal/field/sequence constructed according to the present specification may be transmitted in the form of FIG. 5.

FIG. 28 is a flowchart illustrating the operation of a receiving device according to the present embodiment.

The aforementioned PPDU may be received according to the example of FIG. 28.

The example of FIG. 28 may be performed by a receiving apparatus/device (AP and/or non-AP STA).

Some of each step (or detailed sub-step to be described later) of the example of FIG. 28 may be skipped/omitted.

The receiving device (receiving STA) may receive all or part of the PPDU through step S2810. The received signal may be in the form of FIG. 5.

A sub-step of step S2810 may be determined based on step S2730 of FIG. 27. That is, in step S2810, an operation of restoring the result of the CSD, Spatial Mapping, IDFT/IFFT operation, and GI insertion operation applied in step S2730 may be performed.

In step S2820, the receiving device may perform decoding on all/part of the PPDU. Also, the receiving device may obtain control information related to a tone plan (i.e., RU) from the decoded PPDU.

More specifically, the receiving device may decode the L-SIG and EHT-SIG of the PPDU based on the legacy STF/LTF and obtain information included in the L-SIG and EHT SIG fields. Information on various tone plans (i.e., RUs) described in this specification may be included in the EHT-SIG, and the receiving STA may obtain information on the tone plan (i.e., RU) through the EHT-SIG.

In step S2830, the receiving device may decode the remaining part of the PPDU based on information about the tone plan (i.e., RU) acquired through step S2820. For example, the receiving STA may decode the STF/LTF field of the PPDU based on information about one plan (i.e., RU). In addition, the receiving STA may decode the data field of the PPDU based on information about the tone plan (i.e., RU) and obtain the MPDU included in the data field.

In addition, the receiving device may perform a processing operation of transferring the data decoded through step S2830 to a higher layer (e.g., MAC layer). In addition, when generation of a signal is instructed from the upper layer to the PHY layer in response to data transmitted to the upper layer, a subsequent operation may be performed.

Hereinafter, the above-described embodiment will be described with reference to FIG. 1 to FIG. 28.

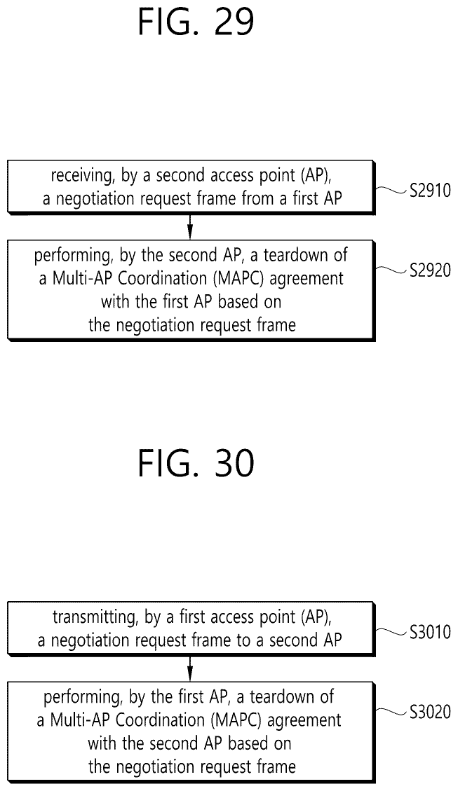

FIG. 29 is a flowchart illustrating a procedure for receiving a frame for performing teardown of a MAPC agreement according to the present embodiment.

The example of FIG. 29 may be performed in a network environment that supports a next-generation wireless LAN system (Ultra High Reliability (UHR) wireless LAN system or next Wi-Fi). The next-generation wireless LAN system is an improved version of the 802.11be system and can satisfy backward compatibility with the 802.11be system.

An example of FIG. 29 may be performed in a second AP. A first AP may be a MAPC requesting AP that initiates MAPC negotiation with the second AP for at least one MAPC scheme. The second AP may be a MAPC responding AP that responds to the MAPC requesting AP. Furthermore, the first and second APs may be configured as coordinating APs or coordinated APs through the MAPC negotiation.

This embodiment proposes a method for defining a frame for performing teardown of a MAPC agreement established through MAPC negotiation. Specifically, this embodiment proposes a method for performing the teardown of the MAPC agreement by defining a negotiation request frame based on a reserved value in the public action field of a public action frame.

In step S2910, a second access point (AP) receives a negotiation request frame from a first AP.

In step S2920, the second AP performs a teardown of a Multi-AP Coordination (MAPC) agreement with the first AP based on the negotiation request frame.

The first AP is a MAPC requesting AP that initiates negotiation for the MAPC agreement. The second AP is a MAPC responding AP that responds to the MAPC requesting AP.

The negotiation request frame is a public action frame having a first value of a public action field. The negotiation request frame is used to teardown the MAPC agreement.

The first value may be set to one of reserved values (e.g., 54 to 59 and 61 to 255) of the public action field for 802.11be wireless LAN system. For example, the first value may be 69.

That is, the present embodiment proposes a method for performing teardown of MAPC agreement by defining a negotiation request frame (or MAPC negotiation request frame) based on a public action frame. Since the negotiation request frame defined based on the public action frame can be classified as a Class I frame, it has the effect that it can be transmitted even between APs that are in an unauthenticated and unassociated relationship, or an authenticated but unassociated relationship. In addition, since there is no need to define a separate dedicated management frame for each procedure such as discovery for MAPC, negotiation for MAPC agreement (MAPC agreement establishment, MAPC agreement update, MAPC agreement teardown), etc., it has the effect that not only MAPC agreement teardown based on the negotiation request frame, but also other negotiation procedures may be performed.

Defining the negotiation request frame based on the public action frame (or the reserved value of the public action field) can have the following effects:

### 1) Ensuring Standardization Compatibility/Interoperability

The Public Action frame, among other management frames, contains universal actions that all STAs can understand. Therefore, defining the action to release MAPC agreement in the Public Action field allows it to be interpreted and processed universally across heterogeneous devices, without being tied to a specific vendor or STA.
This ensures backward compatibility and multi-vendor interoperability.

### 2) Simplified Frame Processing/Reduced Signaling Overhead

By identifying and processing within the Public Action field, rather than defining a separate, dedicated management frame, STAs and APs can leverage existing Public Action frame parsing procedures, supporting backward compatibility and reducing implementation complexity. Furthermore, signaling overhead can be reduced by minimizing frame format expansion.

### 3) Enhanced Security/Reliability

Since the Public Action frame follows a standardized field structure, it can be easily applied to frame forgery/modification verification and integrity verification procedures (e.g., Management Frame Protection-MFP).
Therefore, the reliability of teardown signaling can be ensured.

Furthermore, the method of performing the teardown of the MAPC agreement based on the negotiation request frame can have the following effects:

### 1) Procedure Integration (Unified Management Effect)

Previously, setup/negotiation and release/teardown could be handled as separate mechanisms. However, by integrating these processes within the MAPC Negotiation Request frame, they can be managed within the same protocol context, simplifying control procedures and enabling rapid session release without unnecessary additional frame exchange.

### 2) Improved Resource Management Efficiency

Rapid teardown allows for the rapid release of allocated resources from the AP/STA, enabling them to be reallocated to new sessions or other STAs. This can have the effect of optimizing frequency/time resource utilization.

### 3) Improved Energy Efficiency

From the STA's perspective, if a MAPC session is clearly recognized as being released, it can immediately transition to doze mode, reducing unnecessary reception latency. This can be particularly significant for low-power Internet of Things (IoT) STAs.
   4) Rapid Recovery from Error/Conflict Situations
In multi-AP coordination situations where multiple APs cooperate, immediately notifying a teardown when cooperation is broken reduces interference and redundant resource usage due to abnormal session maintenance, enabling a quick transition to a new agreement process.

The negotiation request frame may include a MAPC element. The MAPC element may include a MAPC Control field, a MAPC Common Info field, and a MAPC Schemes Info field.

The MAPC Control field may include an AP Identifier (ID) presence field and a Reserved field. The AP ID field may be optionally included in the MAPC Common Info field based on a value of the AP ID Present field. The AP ID field may be used to assign an AP ID to a peer AP with which the MAPC agreement has been established.

For example, if/based on an AP ID of the second AP does not match/not matching an AP ID included in the AP ID field, the MAPC agreement with the second AP may be torn down.

The MAPC scheme information field may include a Subelement ID field, a MAPC Scheme Control field, and a MAPC Scheme Request Set field.

Based on a value of the Subelement ID field, the MAPC scheme information field may be defined as a per-Scheme Profile subelement for each MAPC scheme.

The MAPC Scheme Control field may include a MAPC Scheme Type field. The MAPC Scheme Type field may indicate a value that identifies the MAPC scheme.

The MAPC Scheme Request Set field may include a MAPC Operation Type field. Based on a value of the MAPC Operation Type field, an operation is indicated to establish the MAPC agreement, update the MAPC agreement, or teardown the MAPC agreement. For example, based on the value of the MAPC operation type field being 0, the MAPC agreement may be established. Based on the value of the MAPC operation type field being 1, the MAPC agreement may be updated. Based on the value of the MAPC operation type field being 2, the MAPC agreement may be torn down.

The per-Scheme Profile subelement for the each MAPC scheme may include at least one (zero or one) Coordinated beamforming (Co-BF) profile, Coordinated spatial reuse (Co-SR) profile, Coordinated time division multiple access (Co-TDMA) profile, Coordinated restricted target wake time (Co-RTWT) profile, and Coordinated channel recommendation (Co-CR) profile.

The Co-BF profile, the Co-SR profile, the Co-TDMA profile, the Co-RTWT profile, and the Co-CR profile may be identified based on the value of the MAPC Scheme Type field. For example, based on the value of the MAPC Scheme Type field being 0, the Co-BF profile may be included in the per-Scheme Profile subelement. Based on the value of the MAPC Scheme Type field being 1, the Co-SR profile may be included in the per-Scheme Profile subelement. Based on the value of the MAPC Scheme Type field being 2, the Co-TDMA profile may be included in the per-Scheme Profile subelement. Based on the value of the MAPC Scheme Type field being 3, the Co-RTWT profile may be included in the per-Scheme Profile subelement. Based on the value of the MAPC Scheme Type field being 4, the Co-SR profile may be included in the per-Scheme Profile subelement.

The MAPC Scheme Request Set field may be defined for each of the Co-BF profile, the Co-SR profile, the Co-TDMA profile, the Co-RTWT profile, and the Co-CR profile.

Since the MAPC Scheme Request Set field is defined for each MAPC scheme, operations such as establishing the MAPC agreement, updating the MAPC agreement, or performing the teardown of the MAPC agreement may be indicated based on the value of the MAPC Operation Type field for each MAPC scheme.

For example, based on the value of the MAPC Operation Type field of the Co-BF profile being set to 2, the MAPC agreement may be torn down only for Co-BF. Based on the value of the MAPC Operation Type field of the Co-SR profile being set to 2, the MAPC agreement may be torn down only for Co-SR. Based on the value of the MAPC Operation Type field of the Co-TDMA profile being set to 2, the MAPC agreement may be torn down only for Co-TDMA. Based on the value of the MAPC Operation Type field of the Co-RTWT profile being set to 2, the MAPC agreement may be torn down only for Co-RTWT. Based on the value of the MAPC Operation Type field of the Co-CR profile being set to 2, the MAPC agreement may be torn down only for Co-CR.

The above-described embodiment only describes an operation for performing the teardown of the MAPC agreement in which the value of the MAPC Operation Type e field is set to 2, but by setting the value of the MAPC Operation Type field for each MAPC scheme, a specific scheme may indicate MAPC agreement teardown, and another scheme may indicate MAPC agreement establishment or update.

For example, based on the value of the MAPC Operation Type field of the Co-BF profile being set to 2, the MAPC agreement may be torn down for Co-BF. In contrast, based on the value of the MAPC Operation Type field of the Co-SR profile being set to 1, the MAPC agreement may be updated for Co-SR.

After the MAPC agreement is torn down, information on the MAPC agreement is discarded, and the second AP may be excluded from the MAPC agreement.

The second AP may transmit a negotiation response frame to the first AP. (Alternatively, the first AP may receive a negotiation response frame from the second AP.)

The negotiation response frame may be a public action frame defined based on a second value of the public action field (or the negotiation response frame may be a public action frame having a second value of the public action field).

The second value may be set to one of the reserved values (e.g., 54 to 59 and 61 to 255) of the public action field for 802.11be wireless LAN system. For example, the second value may be 70.

The negotiation response frame may also include a MAPC element. The MAPC element may include a MAPC Operation Type field. In the negotiation response frame, a request for the negotiation request frame may be accepted/rejected/alternated based on a value of the MAPC Operation Type field.

The negotiation request frame or the negotiation response frame may include at least one of information on a length, information on a MAPC protocol identifier, information on a Link ID, information on a reason for performing the teardown of the MAPC agreement, information on a Pairwise Master Key (MAPC PMK), information on an address of an AP, information on a group ID of the MAPC, information on an individual ID for the MAPC agreement, information on an ID of the multiple APs, or information on the MAPC-based transmission scheme.

FIG. 30 is a flowchart illustrating a procedure for configuring a frame for performing teardown of a MAPC agreement according to the present embodiment.

The example of FIG. 30 may be performed in a network environment that supports a next-generation wireless LAN system (Ultra High Reliability (UHR) wireless LAN system or next Wi-Fi). The next-generation wireless LAN system is an improved version of the 802.11be system and can satisfy backward compatibility with the 802.11be system.

An example of FIG. 30 may be performed in a first AP. The first AP may be a MAPC requesting AP that initiates MAPC negotiation with a second AP for at least one MAPC scheme. The second AP may be a MAPC responding AP that responds to the MAPC requesting AP. Furthermore, the first and second APs may be configured as coordinating APs or coordinated APs through the MAPC negotiation.

This embodiment proposes a method for defining a frame for performing teardown of a MAPC agreement established through MAPC negotiation. Specifically, this embodiment proposes a method for performing the teardown of the MAPC agreement by defining a negotiation request frame based on a reserved value in the public action field of a public action frame.

In step S3010, a first access point (AP) transmits a negotiation request frame to a second AP.

In step S3020, the first AP performs a teardown of a Multi-AP Coordination (MAPC) agreement with the second AP based on the negotiation request frame.

The first AP is a MAPC requesting AP that initiates negotiation for the MAPC agreement. The second AP is a MAPC responding AP that responds to the MAPC requesting AP.

The negotiation request frame is a public action frame having a first value of a public action field. The negotiation request frame is used to teardown the MAPC agreement.

The first value may be set to one of reserved values (e.g., 54 to 59 and 61 to 255) of the public action field for 802.11be wireless LAN systems. For example, the first value may be 69.

That is, the present embodiment proposes a method for performing teardown of MAPC agreement by defining a negotiation request frame (or MAPC negotiation request frame) based on a public action frame. Since the negotiation request frame defined based on the public action frame can be classified as a Class 1 frame, it has the effect that it can be transmitted even between APs that are in an unauthenticated and unassociated relationship, or an authenticated but unassociated relationship. In addition, since there is no need to define a separate dedicated management frame for each procedure such as discovery for MAPC, negotiation for MAPC agreement (MAPC agreement establishment, MAPC agreement update, MAPC agreement teardown), etc., it has the effect that not only MAPC agreement teardown based on the negotiation request frame, but also other negotiation procedures may be performed.

Defining the negotiation request frame based on the public action frame (or the reserved value of the public action field) can have the following effects:

### 1) Ensuring Standardization Compatibility/Interoperability

>The Public Action frame, among other management frames, contains universal actions that all STAs can understand. Therefore, defining the action to release MAPC agreement in the Public Action field allows it to be interpreted and processed universally across heterogeneous devices, without being tied to a specific vendor or STA.
This ensures backward compatibility and multi-vendor interoperability.

### 2) Simplified Frame Processing/Reduced Signaling Overhead

By identifying and processing within the Public Action field, rather than defining a separate, dedicated management frame, STAs and APs can leverage existing Public Action frame parsing procedures, supporting backward compatibility and reducing implementation complexity. Furthermore, signaling overhead can be reduced by minimizing frame format expansion.

### 3) Enhanced Security/Reliability

Since the Public Action frame follows a standardized field structure, it can be easily applied to frame forgery/modification verification and integrity verification procedures (e.g., Management Frame Protection-MFP).
Therefore, the reliability of teardown signaling can be ensured.

Furthermore, the method of performing the teardown of the MAPC agreement based on the negotiation request frame can have the following effects:

### 1) Procedure Integration (Unified Management Effect)

Previously, setup/negotiation and release/teardown could be handled as separate mechanisms. However, by integrating these processes within the MAPC Negotiation Request frame, they can be managed within the same protocol context, simplifying control procedures and enabling rapid session release without unnecessary additional frame exchange.

### 2) Improved Resource Management Efficiency

Rapid teardown allows for the rapid release of allocated resources from the AP/STA, enabling them to be reallocated to new sessions or other STAs. This can have the effect of optimizing frequency/time resource utilization.

### 3) Improved Energy Efficiency

From the STA's perspective, if a MAPC session is clearly recognized as being released, it can immediately transition to doze mode, reducing unnecessary reception latency. This can be particularly significant for low-power Internet of Things (IoT) STAs.
   4) Rapid Recovery from Error/Conflict Situations
In multi-AP coordination situations where multiple APs cooperate, immediately notifying a teardown when cooperation is broken reduces interference and redundant resource usage due to abnormal session maintenance, enabling a quick transition to a new agreement process.

The negotiation request frame may include a MAPC element. The MAPC element may include a MAPC Control field, a MAPC Common Info field, and a MAPC Schemes Info field.

The MAPC Control field may include an AP Identifier (ID) presence field and a Reserved field. The AP ID field may be optionally included in the MAPC Common Info field based on a value of the AP ID Present field. The AP ID field may be used to assign an AP ID to a peer AP with which the MAPC agreement has been established.

For example, if/based on an AP ID of the second AP does not match/not matching an AP ID included in the AP ID field, the MAPC agreement with the second AP may be torn down.

The MAPC scheme information field may include a Subelement ID field, a MAPC Scheme Control field, and a MAPC Scheme Request Set field.

Based on a value of the Subelement ID field, the MAPC scheme information field may be defined as a per-Scheme Profile subelement for each MAPC scheme.

The MAPC Scheme Control field may include a MAPC Scheme Type field. The MAPC Scheme Type field may indicate a value that identifies the MAPC scheme.

The MAPC Scheme Request Set field may include a MAPC Operation Type field. Based on a value of the MAPC Operation Type field, an operation is indicated to establish the MAPC agreement, update the MAPC agreement, or teardown the MAPC agreement. For example, based on the value of the MAPC operation type field being 0, the MAPC agreement may be established. Based on the value of the MAPC operation type field being 1, the MAPC agreement may be updated. Based on the value of the MAPC operation type field being 2, the MAPC agreement may be torn down.

The per-Scheme Profile subelement for the each MAPC scheme may include at least one (zero or one) Coordinated beamforming (Co-BF) profile, Coordinated spatial reuse (Co-SR) profile, Coordinated time division multiple access (Co-TDMA) profile, Coordinated restricted target wake time (Co-RTWT) profile, and Coordinated channel recommendation (Co-CR) profile.

The Co-BF profile, the Co-SR profile, the Co-TDMA profile, the Co-RTWT profile, and the Co-CR profile may be identified based on the value of the MAPC Scheme Type field. For example, based on the value of the MAPC Scheme Type field being 0, the Co-BF profile may be included in the per-Scheme Profile subelement. Based on the value of the MAPC Scheme Type field being 1, the Co-SR profile may be included in the per-Scheme Profile subelement. Based on the value of the MAPC Scheme Type field being 2, the Co-TDMA profile may be included in the per-Scheme Profile subelement. Based on the value of the MAPC Scheme Type field being 3, the Co-RTWT profile may be included in the per-Scheme Profile subelement. Based on the value of the MAPC Scheme Type field being 4, the Co-SR profile may be included in the per-Scheme Profile subelement.

The MAPC Scheme Request Set field may be defined for each of the Co-BF profile, the Co-SR profile, the Co-TDMA profile, the Co-RTWT profile, and the Co-CR profile.

Since the MAPC Scheme Request Set field is defined for each MAPC scheme, operations such as establishing the MAPC agreement, updating the MAPC agreement, or performing the teardown of the MAPC agreement may be indicated based on the value of the MAPC Operation Type field for each MAPC scheme.

For example, based on the value of the MAPC Operation Type field of the Co-BF profile being set to 2, the MAPC agreement may be torn down only for Co-BF. Based on the value of the MAPC Operation Type field of the Co-SR profile being set to 2, the MAPC agreement may be torn down only for Co-SR. Based on the value of the MAPC Operation Type field of the Co-TDMA profile being set to 2, the MAPC agreement may be torn down only for Co-TDMA. Based on the value of the MAPC Operation Type field of the Co-RTWT profile being set to 2, the MAPC agreement may be torn down only for Co-RTWT. Based on the value of the MAPC Operation Type field of the Co-CR profile being set to 2, the MAPC agreement may be torn down only for Co-CR.

The above-described embodiment only describes an operation for performing the teardown of the MAPC agreement in which the value of the MAPC Operation Type e field is set to 2, but by setting the value of the MAPC Operation Type field for each MAPC scheme, a specific scheme may indicate MAPC agreement teardown, and another scheme may indicate MAPC agreement establishment or update.

For example, based on the value of the MAPC Operation Type field of the Co-BF profile being set to 2, the MAPC agreement may be torn down for Co-BF. In contrast, based on the value of the MAPC Operation Type field of the Co-SR profile being set to 1, the MAPC agreement may be updated for Co-SR.

After the MAPC agreement is torn down, information on the MAPC agreement is discarded, and the second AP may be excluded from the MAPC agreement.

The second AP may transmit a negotiation response frame to the first AP. (Alternatively, the first AP may receive a negotiation response frame from the second AP.)

The negotiation response frame may be a public action frame defined based on a second value of the public action field (or the negotiation response frame may be a public action frame having a second value of the public action field).

The second value may be set to one of the reserved values (e.g., 54 to 59 and 61 to 255) of the public action field for 802.11be wireless LAN system. For example, the second value may be 70.

The negotiation response frame may also include a MAPC element. The MAPC element may include a MAPC Operation Type field. In the negotiation response frame, a request for the negotiation request frame may be accepted/rejected/alternated based on a value of the MAPC Operation Type field.

The negotiation request frame or the negotiation response frame may include at least one of information on a length, information on a MAPC protocol identifier, information on a Link ID, information on a reason for performing the teardown of the MAPC agreement, information on a Pairwise Master Key (MAPC PMK), information on an address of an AP, information on a group ID of the MAPC, information on an individual ID for the MAPC agreement, information on an ID of the multiple APs, or information on the MAPC-based transmission scheme.

### <Device Configuration>

The technical features of the present disclosure may be applied to various devices and methods. For example, the technical features of the present disclosure may be performed/supported through the device(s) of FIG. 1 and/or FIG. 13. For example, the technical features of the present disclosure may be applied to only part of FIG. 1 and/or FIG. 13. For example, the technical features of the present disclosure may be implemented based on the processing chip(s) 114 and 124 of FIG. 1, or implemented based on the processor(s) 111 and 121 and the memory(s) 112 and 122, or implemented based on the processor 610 and the memory 620 of FIG. 13. For example, the device according to the present disclosure transmits a negotiation request frame to a second access point (AP); and performs a teardown of a Multi-AP Coordination (MAPC) agreement with the second AP based on the negotiation request frame.

The technical features of the present disclosure may be implemented based on a computer readable medium (CRM). For example, a CRM according to the present disclosure is at least one computer readable medium including instructions designed to be executed by at least one processor.

The CRM may store instructions that perform operations including transmitting a negotiation request frame to a second access point (AP); and performing a teardown of a Multi-AP Coordination (MAPC) agreement with the second AP based on the negotiation request frame. At least one processor may execute the instructions stored in the CRM according to the present disclosure. At least one processor related to the CRM of the present disclosure may be the processor 111, 121 of FIG. 1, the processing chip 114, 124 of FIG. 1, or the processor 610 of FIG. 13. Meanwhile, the CRM of the present disclosure may be the memory 112, 122 of FIG. 1, the memory 620 of FIG. 13, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

What is claimed is:

1. A method in a wireless local area network (WLAN) system, the method comprising:
transmitting, by a first access point (AP), a negotiation request frame to a second AP; and
performing, by the first AP, a teardown of a Multi-AP Coordination (MAPC) agreement with the second AP based on the negotiation request frame,
wherein the first AP is a MAPC requesting AP that initiates negotiation for the MAPC agreement,
wherein the second AP is a MAPC responding AP that responds to the MAPC requesting AP,
wherein the negotiation request frame is a public action frame having a first value of a public action field, and
wherein the negotiation request frame is used to teardown the MAPC agreement.

2. The method of claim 1, wherein the negotiation request frame includes a MAPC element,
wherein the MAPC element includes a MAPC Control field, a MAPC Common Info field, and a MAPC Schemes Info field,
wherein the MAPC Control field includes an AP Identifier (ID) presence field and a Reserved field,
wherein the AP ID field is optionally included in the MAPC Common Info field based on a value of the AP ID Present field,
wherein the AP ID field is used to assign an AP ID to a peer AP with which the MAPC agreement has been established.

3. The method of claim 2, wherein the MAPC scheme information field includes a Subelement ID field, a MAPC Scheme Control field, and a MAPC Scheme Request Set field,
wherein based on a value of the Subelement ID field, the MAPC scheme information field is defined as a per-Scheme Profile subelement for each MAPC scheme,
wherein the MAPC Scheme Control field includes a MAPC Scheme Type field,
wherein the MAPC Scheme Type field indicates a value that identifies the MAPC scheme,
wherein the MAPC Scheme Request Set field includes a MAPC Operation Type field,
wherein based on a value of the MAPC Operation Type field, an operation is indicated to establish the MAPC agreement, update the MAPC agreement, or teardown the MAPC agreement.

4. The method of claim 3, wherein the per-Scheme Profile subelement for the each MAPC scheme includes at least one Coordinated beamforming (Co-BF) profile, Coordinated spatial reuse (Co-SR) profile, Coordinated time division multiple access (Co-TDMA) profile, Coordinated restricted target wake time (Co-RTWT) profile, and Coordinated channel recommendation (Co-CR) profile,
wherein the Co-BF profile, the Co-SR profile, the Co-TDMA profile, the Co-RTWT profile, and the Co-CR profile is identified based on the value of the MAPC Scheme Type field,
wherein the MAPC Scheme Request Set field is defined for each of the Co-BF profile, the Co-SR profile, the Co-TDMA profile, the Co-RTWT profile, and the Co-CR profile.

5. The method of claim 4, wherein based on the value of the MAPC Operation Type field of the Co-BF profile being set to 2, the MAPC agreement is torn down only for Co-BF,
wherein based on the value of the MAPC Operation Type field of the Co-SR profile being set to 2, the MAPC agreement is torn down only for Co-SR,
wherein based on the value of the MAPC Operation Type field of the Co-TDMA profile being set to 2, the MAPC agreement is torn down only for Co-TDMA,
wherein based on the value of the MAPC Operation Type field of the Co-RTWT profile being set to 2, the MAPC agreement is torn down only for Co-RTWT,
wherein based on the value of the MAPC Operation Type field of the Co-CR profile being set to 2, the MAPC agreement is torn down only for Co-CR.

6. The method of claim 1, further comprising:
receiving, by the first AP, a negotiation response frame from the second AP,
wherein the negotiation response frame is a public action frame defined based on a second value of the public action field,
wherein the first value is 69 and the second value is 70.

7. The method of claim 1, wherein after the MAPC agreement is torn down, information on the MAPC agreement is discarded, and the second AP is excluded from the MAPC agreement.

8. A first access point (AP) in a wireless local area network (WLAN) system, the first AP comprising:
a memory;
a transceiver; and
a processor being operatively connected to the memory and the transceiver,
wherein the processor is configured to:
transmit a negotiation request frame to a second AP; and
perform a teardown of a Multi-AP Coordination (MAPC) agreement with the second AP based on the negotiation request frame,
wherein the first AP is a MAPC requesting AP that initiates negotiation for the MAPC agreement,
wherein the second AP is a MAPC responding AP that responds to the MAPC requesting AP,
wherein the negotiation request frame is a public action frame having a first value of a public action field, and
wherein the negotiation request frame is used to teardown the MAPC agreement.

9. A method in a wireless local area network (WLAN) system, the method comprising:
receiving, by a second access point (AP), a negotiation request frame from a first AP; and
performing, by the second AP, a teardown of a Multi-AP Coordination (MAPC) agreement with the first AP based on the negotiation request frame,
wherein the first AP is a MAPC requesting AP that initiates negotiation for the MAPC agreement,
wherein the second AP is a MAPC responding AP that responds to the MAPC requesting AP,
wherein the negotiation request frame is a public action frame having a first value of a public action field, and
wherein the negotiation request frame is used to teardown the MAPC agreement.

10. The method of claim 9, wherein the negotiation request frame includes a MAPC element,
wherein the MAPC element includes a MAPC Control field, a MAPC Common Info field, and a MAPC Schemes Info field,
wherein the MAPC Control field includes an AP Identifier (ID) presence field and a Reserved field,
wherein the AP ID field is optionally included in the MAPC Common Info field based on a value of the AP ID Present field,
wherein the AP ID field is used to assign an AP ID to a peer AP with which the MAPC agreement has been established.

11. The method of claim 10, wherein the MAPC scheme information field includes a Subelement ID field, a MAPC Scheme Control field, and a MAPC Scheme Request Set field,
wherein based on a value of the Subelement ID field, the MAPC scheme information field is defined as a per-Scheme Profile subelement for each MAPC scheme,
wherein the MAPC Scheme Control field includes a MAPC Scheme Type field,
wherein the MAPC Scheme Type field indicates a value that identifies the MAPC scheme,
wherein the MAPC Scheme Request Set field includes a MAPC Operation Type field,
wherein based on a value of the MAPC Operation Type field, an operation is indicated to establish the MAPC agreement, update the MAPC agreement, or teardown the MAPC agreement.

12. The method of claim 11, wherein the per-Scheme Profile subelement for the each MAPC scheme includes at least one Coordinated beamforming (Co-BF) profile, Coordinated spatial reuse (Co-SR) profile, Coordinated time division multiple access (Co-TDMA) profile, Coordinated restricted target wake time (Co-RTWT) profile, and Coordinated channel recommendation (Co-CR) profile,
wherein the Co-BF profile, the Co-SR profile, the Co-TDMA profile, the Co-RTWT profile, and the Co-CR profile is identified based on the value of the MAPC Scheme Type field,
wherein the MAPC Scheme Request Set field is defined for each of the Co-BF profile, the Co-SR profile, the Co-TDMA profile, the Co-RTWT profile, and the Co-CR profile.

13. The method of claim 12, wherein based on the value of the MAPC Operation Type field of the Co-BF profile being set to 2, the MAPC agreement is torn down only for Co-BF,
wherein based on the value of the MAPC Operation Type field of the Co-SR profile being set to 2, the MAPC agreement is torn down only for Co-SR,
wherein based on the value of the MAPC Operation Type field of the Co-TDMA profile being set to 2, the MAPC agreement is torn down only for Co-TDMA,
wherein based on the value of the MAPC Operation Type field of the Co-RTWT profile being set to 2, the MAPC agreement is torn down only for Co-RTWT,
wherein based on the value of the MAPC Operation Type field of the Co-CR profile being set to 2, the MAPC agreement is torn down only for Co-CR.

14. The method of claim 9, further comprising:
transmitting, by the second AP, a negotiation response frame to the first AP,
wherein the negotiation response frame is a public action frame defined based on a second value of the public action field,
wherein the first value is 69 and the second value is 70.

15. The method of claim 9, wherein after the MAPC agreement is torn down, information on the MAPC agreement is discarded, and the second AP is excluded from the MAPC agreement.
